(19) United States
(12) Patent Application Publication
(10) Pub. No.: US 2012/0182865 A1
(43) Pub. Date: Jul. 19, 2012

(54) Systems, Methods, and Apparatuses for Managing the Flow of Traffic in Data Networks

(75) Inventors: Allan T. Andersen, Cranford, NJ (US); Scott J. Muller, Berlin (DE); Aroon U. Naidu, Bridgewater, NJ (US); Stephen J. Goett, Bridgewater, NJ (US)

(73) Assignee: VPIsystems, Inc., Somerset, NJ (US)

(21) Appl. No.: 13/148,241

(22) PCT Filed: Feb. 5, 2010
(86) PCT No.: PCT/US10/00345

§ 371 Date: Mar. 21, 2012

Related U.S. Application Data
(60) Provisional application No. 61/202,218, filed on Feb. 6, 2009.

(51) Int. Cl. H04L 12/24; H04L 12/26

(52) U.S. Cl. 370/228; 370/238

(57) ABSTRACT

Methods or systems for management and/or optimization of at least a portion of a data network by generating a set of paths between each origin and destination pair, pruning the set of paths to generate a pruned set of paths; and computing an optimum path between each origin and destination pair. Methods and systems for generating a diverse set of path options for the routing of traffic within at least a portion of a network comprising: generating a set of paths between each origin and destination pair; and pruning the set of paths to generate a pruned set of diverse path options within at least a portion of a network.

### CROSS-REFERENCE TO RELATED APPLICATIONS

This application claims the benefit of priority from U.S. Provisional Application No. 61/202,218, filed Feb. 6, 2009. Additionally, this application is related to PCT/AU2005/000909, filed 23 Jun. 2005, entitled “A Network Optimization System,” and Australian Provisional Application No. 2004903439, filed 23 Jun. 2004, entitled “A Network Optimization System.” Each of the foregoing applications is herein incorporated by reference in their entirety.

### BACKGROUND

1. Field of the Disclosure

The present disclosure relates generally to data networking and more specifically, but without limitation, to systems, methods and apparatuses for managing and/or optimizing traffic flow in such data networks.

2. Description of Related Art

Routing of data (e.g., data packets or other discrete commodities) within data networks is subject to several constraints. For example, one such constraint includes the available capacity of links connecting network nodes. In a communications network, such as a Multi-Protocol Label Switching (MPLS) network, packets traverse designated routes between an origin and destination point. Managing the traffic flow in these networks involves optimizing the selection of these routes to minimize congestion and packet loss within the network.

Current industry practice related to optimization typically involves selecting the shortest path first (SPF) between each origin and destination node, here also called origin/destination pair (OD pair), based on a set of optimized link metrics or link weights and the Dijkstra algorithm. Dealing with unforeseen events is often done by over-provisioning in the capacity planning process to protect against bottlenecks that may occur. Typically, carriers use a maximum link utilization of 20%-40% as a trigger point for adding additional capacity. Accordingly, if utilization of the network reaches 30%, for example, the carrier adds additional capacity to the network. This practice is expensive for carriers.

For example, current methods for optimization use a maximum link utilization objective function and examine several heuristics, including an incremental approach, but there is no indication that this method can be used to handle network failure scenarios. Other approaches employ genetic algorithms (GAs) with specialized fitness functions. These approaches find the best solution based on a pre-assigned fitness function. In another approach, a two-phased approach is adopted where, SPF-link weights are partially optimized using an evolutionary algorithm and then further optimization is performed by heuristic and linear programming techniques.

There are also several other approaches to managing traffic flow but none of these methods can be performed in real-time or substantially real-time. Managing and/or optimizing traffic flow in real-time or substantially real-time may reduce the effects of unforeseen events such as topology disruption or abrupt demand changes and reduce the need for over-provisioning.

Accordingly, what is needed are systems, methods and/or apparatus for managing and/or optimizing traffic flow in data networks in real-time, substantially real-time, and/or some longer time period. Also needed are systems, methods and/or apparatus for generating path options for routing traffic within at least a portion of a network. These and other needed solutions will become apparent from what is disclosed herein.

### DETAILED DESCRIPTION

Exemplary embodiments described herein provide systems, methods and/or apparatus for managing traffic flow in data networks in real time or substantially real time. Exemplary embodiments described herein provide a method for optimizing a data network by generating a set of paths between each origin and destination pair, pruning the set of paths to generate a pruned set of paths, and computing an optimum path between each origin and destination pair. In embodiments, the path generation and pruning as well as the optimization are performed in substantially real time.

In exemplary embodiments, the data network may be a Multi-Protocol Label Switching (MPLS) network. In other exemplary embodiments the data network may be a switched Ethernet network (such as a data center communication environment) or optical or other suitable types of connection oriented packet switched transport network.

In exemplary embodiments, the method may be divided into at least two stages including a path generation and pruning (PGP) phase and an optimization phase and both the PGP phase and the optimization phase may be performed in substantially real time.

In exemplary embodiments, the term “real-time” describes the time required to reach a solution to the network optimization request and is often dependent on the size and state of the network. In exemplary embodiments, “real-time” may be on the order of milliseconds up to seconds (e.g., about 1 msec, about 2 msec, about 5 msec, about 10 msec, about 20 msec, about 50 msec, about 75 msec, about 100 msec, about 200 msec, about 500 msec, about 750 msec, about 1 sec, about 2 sec, about 5 sec). In exemplary embodiments, “real-time” may be for example, less than about 1 msec, less than about 2 msec, less than about 5 msec, less than about 10 msec, less than about 20 msec, less than about 50 msec, less than about 75 msec, less than about 100 msec, less than about 200 msec, less than about 500 msec, less than about 750 msec, less than about 1 sec, less than about 2 sec, less than about 5 sec). In certain embodiments, “real-time” may be what ever time frame is acceptable to a carrier (e.g., about 30 sec, about 1 min, about 2 min, about 5 min, about 7 min, about 10 min, about 15 min). In certain, more complex situations, the optimization may take several minutes up to several hours.

In certain embodiments, the time required to manage and/or optimize traffic flow in a network may vary depending on what is acceptable for a particular network or situation. This may also depend on the size and state of the network. Certain embodiments disclose methods or systems for management and/or optimization of various traffic flow aspects, in at least a portion of a network in a time period that is greater than real time or substantially real time. In certain embodiments, some methods and/or systems may be performed real time, or substantially real time, and/or in a time period greater than real time. Various combinations of real time, substantially real time, and/or longer time periods are contemplated in the methods and/or systems disclosed.

In certain embodiments, the PGP phase may be performed using a Stitch Pruning (SP) approach.

In certain exemplary embodiments, the PGP phase may be performed using a Random Weight Dijkstra (RWD) approach.

In exemplary embodiments, the optimization may be performed using a Local Heuristic Search (LHS) approach. In exemplary embodiments, the LHS approach may be any combination of a sunny day algorithm and a rainy day algorithm.

In exemplary embodiments, the optimization may account for changes in network topology and in some embodiments, may be triggered by the change in network topology.

In exemplary embodiments, the optimization phase may be performed using a genetic algorithm.

In exemplary embodiments, the described methods, systems and apparatuses, may reduce typical over-provisioning within the data network by at least 50%. For example, over provisioning may be reduced by at least about 10%, at least about 20%, at least about 25%, at least about 30%, at least about 40%, at least about 50%, at least about 55% or at least about 60%.

Certain embodiments provide method(s) for optimizing at least a portion of a data network, the method comprising: generating a set of paths between each managed origin and destination pair; pruning the set of paths to generate a pruned set of paths; and computing an optimum path between each managed origin and destination pair; wherein the optimization optionally takes into account a portion of the unmanaged origin and destination pairs within at least a portion of the data network.

Certain embodiments provide method(s) for managing at least a portion of a network, the method comprising: generating a set of paths between each managed origin and destination pair; pruning the set of paths to generate a pruned set of paths; and computing an optimum path between each managed origin and destination pair; wherein the optimization optionally takes into account a portion of the unmanaged origin and destination pairs within at least a portion of the network.

In some aspects, the optimization takes into account substantially all of the unmanaged origin and destination pairs within at least a portion of the data network.

In some aspects, the optimization takes into account all of the unmanaged origin and destination pairs within at least a portion of the data network. In some aspects, at least one of the following is performed in a time period that is longer than substantially real time: the path generation phase, the pruning phase or the optimization phase. In some aspects, the method is divided into at least two stages including a path generation and pruning phase as well as an optimization phase and wherein the optimization phase is performed in substantially real time. In some aspects, the path generation and pruning phase as well as the optimization phase are performed in substantially real time. In some aspects, the path generation and pruning phase is performed using a Stitch Path—Path Generation Pruner (SP PGP). In some aspects, the path generation and pruning phase is performed with Random Weight Dijkstra Path Generation Pruner (RWD PGP). In some aspects, the RWD PGP generates paths for managed origin destination pairs where there are multiple destinations. In some aspects, the optimization is performed using a Local Heuristic Search (LHS) approach. In some aspects, the LHS approach includes a sunny day algorithm or a rainy day algorithm. In some aspects, the optimization phase is performed using a genetic algorithm. In some aspects, the optimization accounts for changes in network topology.

In some aspects, the optimization phase is performed in less than 60 seconds. In some aspects, the path generation and pruning phase is performed in less than 60 seconds. In some aspects, the optimizing method is performed in less than 60 seconds.

In some aspects, over-provisioning within the data network is reduced by at least 50%. In some aspects, the peak-link utilization is improved by about 25%.

In some aspects, the data network is a Multi-Protocol Label Switching (MPLS) network. In some aspects, the data network is a switched Ethernet network. In some aspects, the data network is a data center communications environment. In some aspects, the data network is an optical network. In some aspects, the data network is a connection oriented packet switched transport network.

In some aspects, at least one of the optimization phase, the path generation phase and the pruning phase is performed in substantially real time. In some aspects, the optimization phase, the path generation phase and the pruning phase are performed in substantially real time. In some aspects, the method results in a substantially balanced network performance and/or load characteristics.

Certain embodiments provide method(s) for generating a diverse set of path options for the routing of traffic within at least a portion of a network, the method comprising: generating a set of paths between each origin and destination pair; and pruning the set of paths to generate a pruned set of diverse path options within at least a portion of a network.

In some aspects, the path generation and pruning phase is performed in substantially real time. In some aspects, the path generation and pruning phase is performed in an acceptable period of time. In some aspects, the path generation and pruning phase is performed using a Stitch Path—Path Generation Pruner (SP PGP). In some aspects, the path generation and pruning phase is performed with Random Weight Dijkstra Path Generation Pruner (RWD PGP). In some aspects, the RWD PGP generates paths for origin destination pairs where there are multiple destinations. In some aspects, the path generation and pruning phase is performed in less than 60 seconds. In some aspects, the routing network is a Multi-Protocol Label Switching (MPLS) network. In some aspects, the routing network is a switched Ethernet network. In some aspects, the routing network is within a data center communications environment. In some aspects, the routing network is an optical network. In some aspects, the routing network is a connection oriented packet switched transport network. In some aspects, at least a portion of the origin and destination pairs are managed origin and destination pairs. In some aspects, for at least one origination and destination pair one or more of the paths in the diverse set of path options are actively being utilized for carrying traffic or acting as standby in case of failure. In some aspects, some or all origination and destination pairs and at least one of the paths in the diverse path option set has an associated alternative or backup path. In some aspects, at least one of the following is performed in a time period that is longer than substantially real time: the generating of a set of paths between each origin and destination pair; or the pruning of the set of paths to generate a pruned set of diverse path options.

Certain embodiments provide method(s) for managing and/or optimizing traffic flow in at least a portion of a network, the method comprising: based on a configured or provided set of path options between each origin and destination pair in at least a portion of the network; select one or more of the paths from the path option set of each managed origin and destination pair in real time, or in substantially real time; wherein the path selection may take into account none or a portion of the unmanaged origin and destination pairs within at least a portion of the network. In some aspects, the management and/or optimization takes into account substantially all of the unmanaged origin and destination pairs within at least a portion of the network. In some aspects, the management and/or optimization is performed using a Local Heuristic Search (LHS) approach. In some aspects, the LHS approach includes a sunny day algorithm. In some aspects, the LHS approach includes a rainy day algorithm. In some aspects, the management and/or optimization accounts for changes in network topology. In some aspects, the management and/or optimization is performed using a genetic algorithm. In some aspects, the data network is a Multi-Protocol Label Switching (MPLS) network. In some aspects, the data network is a switched Ethernet network. In some aspects, at least a portion of the network is a data center communications environment. In some aspects, at least a portion of the network is an optical network. In some aspects, at least a portion of the network is a connection oriented packet switched transport network.

Certain embodiments provide method(s) for optimizing at least a portion of a data network, the method comprising: means for generating a set of paths between each managed origin and destination pair; means for pruning the set of paths to generate a pruned set of paths; and means for computing an optimum path between each managed origin and destination pair; wherein the optimization optionally takes into account a portion of the unmanaged origin and destination pairs within at least a portion of the data network.

Certain embodiments provide method(s) for managing at least a portion of a network, the method comprising: means for generating a set of paths between each managed origin and destination pair; means for pruning the set of paths to generate a pruned set of paths; and means for computing an optimum path between each managed origin and destination pair; wherein the optimization optionally takes into account a portion of the unmanaged origin and destination pairs within at least a portion of the data network.

Certain embodiments provide method(s) for optimizing at least a portion of a data network, the method comprising: means for generating a set of paths between each managed origin and destination pair; means for pruning the set of paths to generate a pruned set of paths; and means for computing an optimum path between each managed origin and destination pair; wherein the optimization optionally takes into account a portion of the unmanaged origin and destination pairs within at least a portion of the data network.

Certain embodiments provide method(s) for generating diverse path options for the routing of traffic within at least a portion of a network, the method comprising: means for generating a set of paths between each origin and destination pair; and means for pruning the set of paths to generate a pruned set of paths that may be used for establishing a set of alternative path options within at least a portion of a network.

Certain embodiments provide method(s) for managing and/or optimizing traffic flow in at least a portion of a network, the method comprising: means for determining, computing, calculating and/or providing a subset of managed paths between each origin and destination pair in at least a portion of the network; and means for computing alternative path options between each managed origin and destination pair in real time, or in substantially real time; wherein the alternative paths options take into account at least a portion of the unmanaged origin and destination pairs within at least a portion of the network.

Certain embodiments provide method(s) for managing and/or optimizing traffic flow in a data network, the method comprising: means for determining, computing, calculating and/or providing a subset of managed paths between each origin and destination pair in the data network; and means for computing an optimum path between each managed origin and destination pair in real time or in substantially real time; wherein the optimization takes into account a portion of the unmanaged origin and destination pairs within the data network.

Certain embodiments provide method(s) for managing and/or optimizing traffic flow in at least a portion of a network, the method comprising: based on a configured or provided set of path options between each origin and destination pair in at least a portion of the network; means for selecting one or more of the paths from the path option set of each managed origin and destination pair in real time, or in substantially real time; wherein the path selection may take into account none or a portion of the unmanaged origin and destination pairs within at least a portion of the network.

Certain embodiments provide system(s) for optimizing at least a portion of a data network, the system comprising: a processor for generating a set of paths between each managed origin and destination pair; a processor for pruning the set of paths to generate a pruned set of paths; and a process for computing an optimum path between each managed origin and destination pair; wherein the optimization optionally takes into account a portion of the unmanaged origin and destination pairs within at least a portion of the data network.

Certain embodiments provide system(s) for managing at least a portion of a network, the system comprising: a processor for generating a set of paths between each managed origin and destination pair; a processor for pruning the set of paths to generate a pruned set of paths; and a processor for computing an optimum path between each managed origin and destination pair; wherein the optimization optionally takes into account a portion of the unmanaged origin and destination pairs within at least a portion of the network.

Certain embodiments provide system(s) for generating diverse path options for the routing of traffic within at least a portion of a network, the system comprising: a processor for generating a set of paths between each origin and destination pair; and a processor for pruning the set of paths to generate a pruned set of paths that may be used for establishing a set of alternative path options within at least a portion of a network.

Certain embodiments provide system(s) for managing and/or optimizing traffic flow in a data network, the system comprising: a processor for determining, computing, calculating and/or providing a subset of managed paths between each origin and destination pair in the data network; and a processor computing an optimum path between each managed origin and destination pair in real time or in substantially real time; wherein the optimization takes into account a portion of the unmanaged origin and destination pairs within the data network.

Certain embodiments provide a processor readable medium containing instructions to cause a machine to perform the methods disclosed herein.

### BRIEF DESCRIPTION OF THE DRAWINGS

Additional features and advantages of the instant disclosure will become apparent from the description of embodiments in conjunction with the accompanying drawings where like reference numerals indicate like features, in which:

FIG. 1 illustrates an exemplary embodiment of a high-level functional architecture for managing traffic flow in data networks in real time or substantially real time;

FIG. 2 provides an exemplary embodiment of an interaction diagram of an exemplary two-phased management of traffic flow;

FIG. 3 is a flow chart of an exemplary embodiment of the PGP phase in accordance with exemplary embodiments disclosed herein;

FIG. 4 illustrates an exemplary embodiment of the link data structure that may be used in exemplary embodiments;

FIG. 5 illustrates an exemplary sunny day LHS approach in accordance with exemplary embodiments disclosed herein;

FIG. 6 illustrates an exemplary rainy day LHS approach in accordance with exemplary embodiments disclosed herein;

FIG. 7 illustrates results from an exemplary implementation of the sunny day LHS approach in accordance with exemplary embodiments described herein;

FIG. 8 is a genomic representation of a routing solution using a GA algorithm in accordance with exemplary embodiments described herein;

FIG. 9 is an exemplary representation of a GA control loop interacting with external signals in accordance with exemplary embodiments described herein;

FIG. 10 illustrates the performance of the GA optimizer under non-failure conditions in accordance with exemplary embodiments described herein;

FIG. 11 illustrates the performance of the GA optimizer under conditions of 12 links failing simultaneously in accordance with exemplary embodiments described herein;

FIG. 12 illustrates an exemplary capacity planning process in accordance with exemplary embodiments described herein;

FIG. 13 illustrates an exemplary interaction between capacity planning and intelligent routing in accordance with exemplary embodiments described herein;

FIG. 14 illustrates an exemplary embodiment of the difference between good balance and bad balance in terms of link utilization (the complement of balance) in accordance with exemplary embodiments described herein;

FIG. 15 illustrates exemplary topology of a network, including OD Pairs, Paths and Candidate path sets in accordance with exemplary embodiments described herein;

FIG. 16 illustrates exemplary topology of a network, including OD Pairs, Paths and Candidate path sets in accordance with exemplary embodiments described herein;

FIG. 17 illustrates the interaction of the GA and LHS components of the network optimization system in accordance with exemplary embodiments described herein;

FIG. 18 illustrates an embodiments of the full LHS optimization process including both the rainy and sunny day optimization in accordance with exemplary embodiments described herein;

FIG. 19 illustrates a crossover in connection with the GA algorithm in accordance with exemplary embodiments described herein;

FIG. 20 illustrates a random mutation in connection with the GA algorithm in accordance with exemplary embodiments described herein; and

FIG. 21 illustrates and exemplary topology of a data center network, including OD Pairs, Paths and Candidate path sets in accordance with exemplary embodiments described herein.

FIG. 22 illustrates the path stitching approach employed by the Stitch Pruner (SP) PGP, in accordance with certain embodiments.

FIG. 23 is a flow chart illustrating an exemplary embodiment of the Stitch Pruner (SP) PGP.

FIG. 24 is a flow chart illustrating an exemplary embodiment of the Random Weight Dijkstra (RWD) PGP.

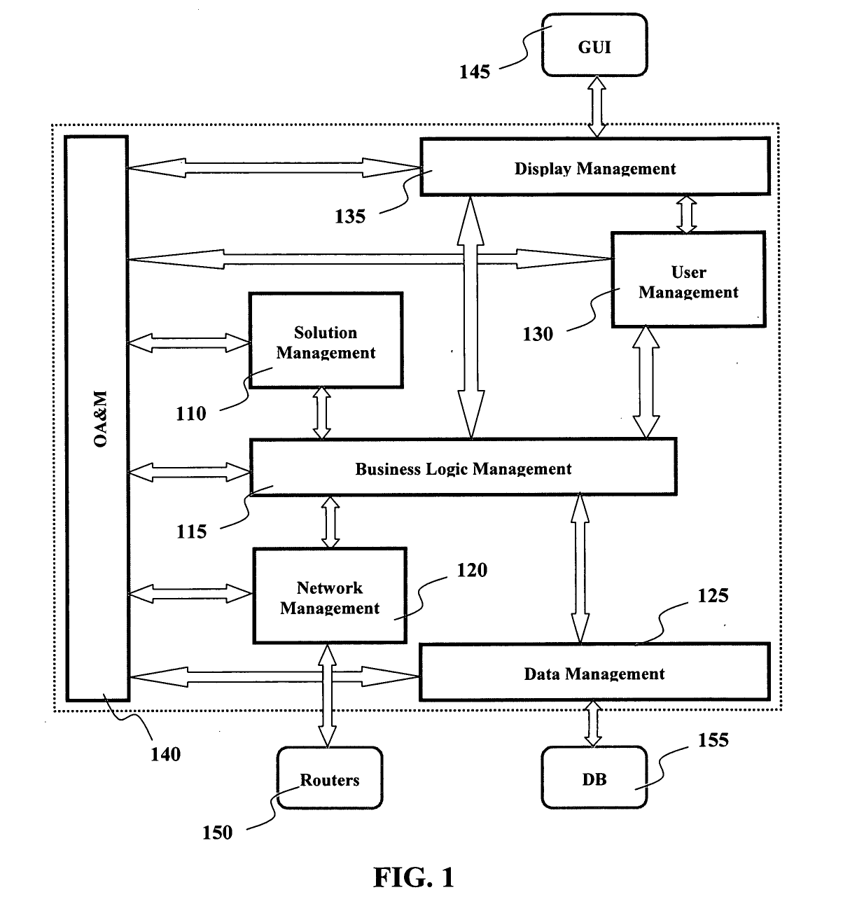

FIG. 1 illustrates an exemplary embodiment of a high-level functional architecture for managing and/or optimizing traffic flow in data networks in real time or substantially real time. In particular, FIG. 1 illustrates an exemplary embodiment of a system for implementing an exemplary two-phased, real-time fault tolerant intelligent routing system 100.

In certain exemplary embodiments, the term “real-time” describes the time required to reach a solution to the optimization request and is often dependent on the size and state of the network. In certain embodiments, the term “real-time” describes the time required to reach a solution that permits the data flow within the network to be reasonably managed and is often dependent on the size and state of the network. This time may vary. In certain exemplary embodiments, “real-time” may be on the order of milliseconds up to seconds (e.g., about 1 msec, about 2 msec, about 5 msec, about 10 msec, about 20 msec, about 50 msec, about 75 msec, about 100 msec, about 200 msec, about 500 msec, about 750 msec, about 1 sec, about 2 sec, about 5 sec). In certain exemplary embodiments, “real-time” may be for example, less than about 1 msec, less than about 2 msec, less than about 5 msec, less than about 10 msec, less than about 20 msec, less than about 50 msec, less than about 75 msec, less than about 100 msec, less than about 200 msec, less than about 500 msec, less than about 750 msec, less than about 1 sec, less than about 2 sec, less than about 5 sec). In certain embodiments, “real-time” may be what ever time frame is acceptable to a carrier (e.g., about 30 sec, about 1 min, about 2 min, about 5 min, about 10 min., about 20 min, about 1 hour, about 2 hours, etc.). In certain, more complex situations, the optimization may take several minutes up to several hours.

In certain embodiments, the time required to manage and/or optimize traffic flow in a network may vary depending on what is acceptable for a particular network or situation. This may also depend on the size and state of the network. In certain embodiments, the time required may be greater than “real time” or “substantially real time”. For example, in some applications it may be impractical to allow for network changes outside a given hourly, daily or weekly time window. For such applications, more optimal solutions may be found by relaxing a real time or substantially real time requirement to a requirement of being able to meet the appropriate time window. In applications where operator review and possibly higher level management approval is required before implementing a solution on the network, the real time requirement may also be relaxed to correspond to the time scale on which the review and approval process takes place. In some applications it may take a considerable amount of time to implement a new solution on the network, in such cases, the real time requirement may also be relaxed to correspond to the time scale on which the implementation takes place. Those skilled in the art will readily recognize that there may be other scenarios where a real time requirement is not desired for the application.

In FIG. 1, the solution management module 110 is generally responsible for generating, for each OD pair, a candidate set of paths (e.g., label switched paths (LSPs) or IP routes) that utilize active links while respecting any initial constraints that may be placed upon the OD pair. Although exemplary embodiments are described throughout the specification using LSPs, it should be readily understood be a person or ordinary skill in the art that the terms “paths”, “LSPs” and “IP routes” can be used interchangeably.

Once the candidate set of paths has been determined, the solution management module 110 selects the optimal candidate path for each OD pair such that an overall objective function value (e.g., Balance) is optimized for a given set of demands placed upon the OD Pairs. In certain exemplary embodiments, “balance” may be a measure of general network load and may be defined as:

$$Balance , B = 1 - γ$$

$$where γ = \frac{load in bits on the maximally proportionally loaded link}{\begin{matrix}total capacity in bits on the \\ maximally proportionally loaded link\end{matrix}} .$$

In this embodiment, balance is the fractional spare capacity available on a particular link in the network that is carrying the most traffic relative to its total capacity. The routing optimization problem, with respect to balance, then becomes: how to configure the routing of traffic given a traffic demand for all OD pairs such that balance is maximized. That is spare capacity on the most heavily loaded link (e.g., in percentage terms) is maximized.

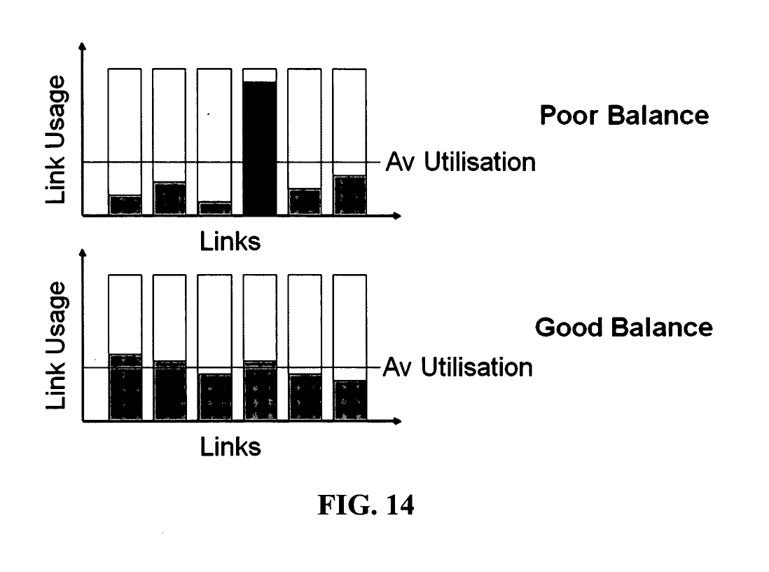

FIG. 14 illustrates an exemplary embodiment of the difference between good balance and bad balance in terms of link utilization (the complement of balance) for the same average link load. Balance is one example of an objective function, a function that provides a metric that can be used to assess the quality of a routing solution. Such a metric may be maximized (or minimized depending on the metric) in the optimization problem. The choice of objective function depends on what network performance and load characteristics are desired. Possible objective functions include, for example, balance (minimize load on heaviest loaded link), linear (minimize the sum of all link loads), exponential bias (minimize the sum of exponentially weighted link loads), minimization of network delay or embodiments thereof. The systems described herein are capable of generating routing solutions using various contextually definable objective functions.

The solution management module 110 interacts with the business logic management module 115. In the embodiment in FIG. 1, the solution management module 110 does not interact directly with either the network module 120 or the data management module 125. In exemplary embodiments, this lack of interaction may be desirable because it provides a decoupling of the solution management module 110 from the rest of the system 100 and therefore, provides a pluggable design which may, in exemplary embodiments, allow for various implementations of the solution management module 110. However, in other embodiments the solution management module may interact directly with either the network module or the data management module. In certain exemplary embodiments, the solution management module contains both phases of the two-phase approach described herein.

Additionally, the GUI application 145 provides the capability for one or more operators to monitor and control the operations of the runtime aspects of the application. Various parameters such as polling time for data acquisition or trigger threshold for an optimized solution as well as the control for review and release can be controlled through this functional component. In addition, various current and historical performance metrics (e.g. estimated link utilization) will be displayed in either a graphical or report format through this application. The functional components of the server are depicted within the dotted box in FIG. 1. The server supports, for example, an http-based interface to the GUI application 145, as well as both Command Line Interface (CLI) and Simple Network Management Protocol (SNMP) based interfaces to the routers and Java Database Connectivity (JDBC) interface to a relational database 155. In certain exemplary embodiments, the server may be comprised of numerous functional components as described herein. The OA&M functional component 140 provides a consistent strategy for the configuration, logging and lifecycle management needs (i.e. startup/shutdown) of the overall server. It may also provide a simple command line interface through which various administrative server related actions can be executed (e.g. shutdown server, modify logging profile, etc.). Other functional components interact with OA&M 140 for these services. The Display Management functional component 135 translates, for example, http requests received from the GUI Application 145 into method calls on the business logic. Upon return, it translates the results into appropriate http responses that are sent back to the GUI Application 145. In addition, Display Management 135 interacts with User Management 130 to authenticate and authorize a user upon login and to retrieve notifications targeted for a specific GUI instance generated by the business logic. Display Management 135 may also serve as a depot for the GUI Application software which is downloaded to the GUI host, if necessary, when the GUI Application 145 is started. Finally, Display Management 135 manages the SSL connections required to secure the connection between the GUI Application 145 and the server. The User Management functional component 130 manages the data and interactions that are tied to a specific user identity. The responsibilities may include, for example, user authentication and authorization, user and role management (i.e. add/delete/modify) and/or a broadcast and narrowcast notification service based on identity or role. This service is utilized by Business Logic Management 115 to send messages back to the various instances of the GUI Application 145. User Management 130 utilizes Data Management 125 to store user profiles. The Data Management functional component 125 is responsible for the persistence of the data required by the Server. To do this, it maintains a pool of connections to an external RDBMS server and provides an Object to Relation Mapping (ORM) that hides the details of the SQL-based transactions from the higher level application code. The data management functional component 125 is also responsible for updating these objects with new data that is triggered (via Business Logic Management 115) by events such as demand collection or link state change. In addition, it collects, calculates and/or organizes the data required by various reports requested by the GUI 145 through Business Logic Management 115, while also managing the user profiles required by User Management 130. The Network Management functional component 120 provides an abstraction for Business Logic Management 115 of the details involved in sending commands to and receiving notifications from a variety of router manufacturers, router versions and/or access strategies (e.g. CLI versus SNMP). It maintains a single connection to each router and dispatches commands in either a parallel (with respect to router) or serial mode depending on the nature of the action as determined by the business logic 115. One possible implementation of this component, which would be useful in testing and demonstration scenarios, is that it could access a persistent store to serve as a source for this network data. Also this component could provide additional functionality so that these networks resources can be accessed through router proxies (e.g. E-Health) maintained by the customer. In certain exemplary embodiments, the Solution Management functional component 110 is responsible for generating a candidate set of LSPs for each OD pair which utilizes active links while respecting any initial constraints placed upon the OD pair by the customer. Once this candidate set has been found, this component is then responsible for selecting the best candidate for each OD pair from this set such that an overall objective function value (e.g. Balance) is optimized for a given set of demands placed upon these OD pairs. Except for the common OA&M component, Solution Management 110 in this embodiment only interacts with Business Logic Management 115. Specifically, in certain exemplary embodiments, it does not interact directly with either the Network or Data Management components 120 and 125, thus providing the decoupling from the rest of the system required to implement a pluggable design which would allow for various implementations of this component. The Business Logic Management functional component 115 is driven by events arriving from Display and Network Management as well as itself and in turn, coordinates the invocation of methods on Solution, Network, Data and User Management components 110, 120, 125 and 130, respectively. This coordination function may accommodate the asynchronous arrival of these events to protect data structures, as well as a preemption strategy to allow processing triggered by a lower priority event (e.g. demand collection) to be cancelled by the arrival of a higher priority event (e.g. network state change).

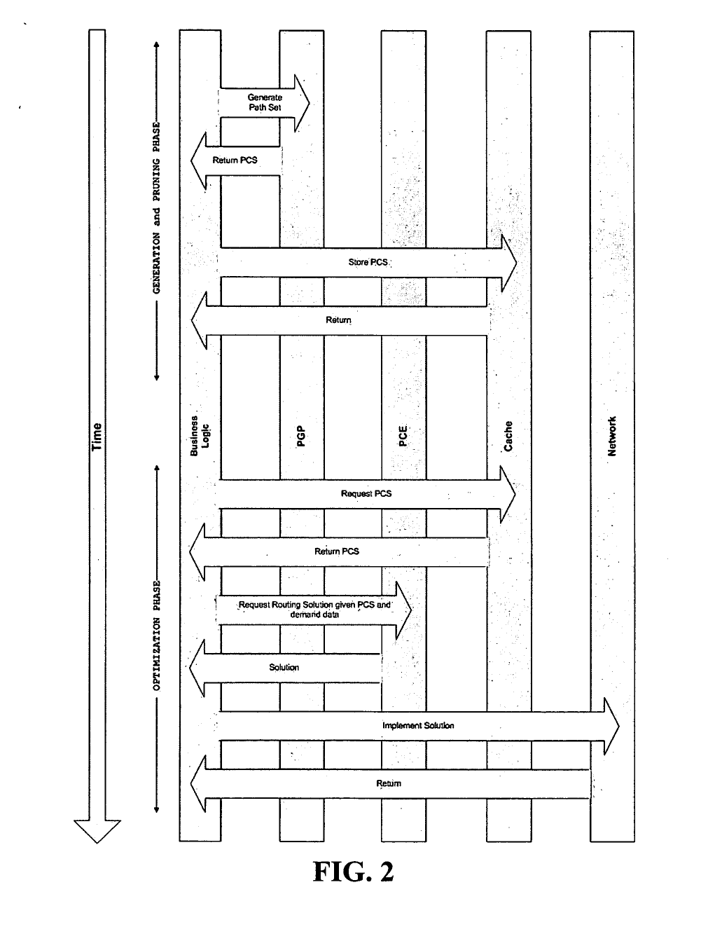

In certain embodiments, the two phases include (1) a Path Generation and Pruning (PGP) phase and (2) Path Computation Element (PCE). FIG. 2 provides an exemplary embodiment of an interaction diagram of the two phases. In the exemplary embodiment illustrated in FIG. 2, the PGP and PCE may be located within the solution management module 110.

As illustrated in FIG. 2, during the PGP phase, the business logic module sends (1) network data and network state information to the PGP which creates a Pruned Candidate Set (PCS) of paths (e.g., LSPs, IP routes) for each OD pair. The Path Computation Engine (PCE) selects a path from the PCS paths that, along with all of the other OD pair/path selections, provides an optimized, global solution.

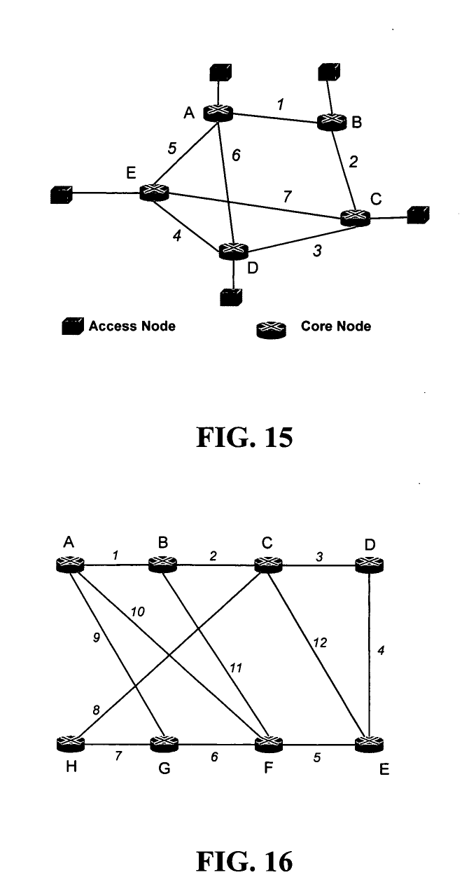

FIG. 15 and FIG. 16 illustrate exemplary topologies of networks, including OD Pairs, Paths and Candidate path sets. FIG. 15 illustrates an example network topology with five core nodes (labeled A to E) and seven core links (labeled 1 to 7): Each core node has connected to it an access node. The access node is where the carriers' customers would connect to the network and nominally where traffic enters or leaves the network. In certain exemplary embodiments, the scope of the methods described herein could be limited to the core nodes of a topology as exemplified by FIG. 16.

An Origination-Destination Pair (OD pair) defines an ordered pair of nodes (Origin node, Destination node) possibly with administrative groups attributes and/or end-to-end attributes as, e.g., maximum hop count and/or maximum latency. These attributes are sometimes referred to as constraints. The administrative groups determine which links the paths associated with the OD pair are allowed to be used. The end-to-end attributes determine the applicability of a given path to the OD pair. Both the administrative groups attributes and the end-to-end attributes can be viewed as way of filtering the paths allowed for a given OD pair. This filtering is done in the PGP phase—hence the paths seen in the optimization phase by the PCE are all filtered paths. In certain cases, neither administrative group attributes nor end-to-end attributes are defined, i.e., no constraints. The traffic enters the network at the origin node, is routed through the network on interconnecting links and then leaves the network at the destination node. For example, on OD pairs between A-C, traffic would enter at node ‘A’ and could travel through links 1 and 2 and then leave the network at node ‘C’. In order to illustrate and keep the description simple at most one OD pair per (Origination node, Destination node) pair is implied in most of the following. This, however, may often be an unnecessary restriction since in some embodiments there could be several OD pairs between a given (Origination node, Destination node) pair—the OD pairs in this case may for example be distinguished by their unique constraints. Some embodiments may employ multiple OD pairs between a given (Origination node, Destination node) pair in order to facilitate traffic load balancing over multiple possibly different paths between the nodes. In this case the traffic between the two nodes is most often equally or substantially equally distributed among the OD pairs. However, a common and simple case is at most one OD pair between a (Origination node,Destination node) pair. Often, a full mesh of OD pairs would be considered, where any node can logically connect to any other node. In this case the OD pairs originating at node ‘A’, would be: A-B, A-C, A-D & A-E. The OD pairs originating at node ‘B’, would be: B-A, B-C, B-D, B-E. Generally, there is an implied direction with an OD pair—the OD pairs A-B is different from B-A. However, the OD pairs A-B and B-A form a pair of OD pairs, with each one considered the reverse of the other. The number of OD pairs for a full mesh network can be calculated as N*(N−1), where N is the number of nodes. In the exemplary network of FIG. 15, there are twenty OD pairs assuming a full mesh. Generally, a full mesh of OD pairs is common practice, however there may be circumstances where a network operator only requires a partial mesh.

A path is a series of one or more links, which connect OD pairs together. An OD pair may have many paths to choose from, although only one may be actively carrying traffic at any specific moment. For example, an OD pair between A-B may use the path containing link {1} to send traffic from A to B or it may use the path containing the links, {5, 7, 2}. A set of paths for an OD pair between A-B may consist of the following: [{1}, {6, 3, 2}, {5, 4, 3, 2}, {5, 7, 2}]. In general, it is common practice for traffic flowing between a pair of OD pairs to use the same links. For example, an OD pair between A-C might use the path {5, 7} and an OD pair C-A would likely use the path {7, 5}. There is however, no requirement for this to be the case and an OD pair between C-A may just as easily use the path {2, 1}. In certain embodiments, particularly when considering MPLS and IP route paths, it may be advantageous to allow a type of path into the path set for an OD pair. This type of path—called the equal cost multiple paths (ECMP) path—describes the impact of the default traffic flow for a given OD pair. In other words, the ECMP path may describe what can be labeled as the default behavior. In, for instances, MPLS and IP networks using an Interior Gateway Protocol (IGP) the default path may be the shortest path as measured by the link metrics. In case several shortest paths exist between a given origin and destination node the traffic is most often load balanced or substantially load balanced, over the existing shortest paths. A compact way of describing the network influence of a load balanced set of shortest paths, an ECMP path, is to enhance the previous definition of a path, i.e., a list of links, to a list of pairs of the type (link id, flow %). The link id identifies the link used and the flow % identifies the percentage of the total OD pair traffic flow this particular link would handle. An example of an ECMP path is an OD pair between A-C and assume all link weights are 1. In this example, the two shortest paths {1,2} respectively {6,3) and the resulting ECMP structure can be represented as {(1, 50%), (2, 50%), (6, 50%), (3, 50%)}. In certain instances, each OD pair has at most one ECMP path in its path set. The ECMP structure may be a generalization of the previously used path description, the previously described paths can each readily be described by an ECMP structure where the flow % on each link would be 100%, or approximately 100%. The inclusion of the ECMP path into the path set allows for significant practical advantages for network operations in that it allows for only actively changing network configuration, when optimization suggests traffic flows different from the ECMP flow or default flow, for a particular OD pair. This inclusion may remove the necessity of having to initially convert the traffic between all OD pairs to explicit paths, which could be prohibitively intrusive on bigger networks (e.g., over 1000, 2000, 5000, 10000, 20000, 50000, 100000, 200000, 500000 or 1000000 OD pairs). Also, the inclusion allows for greater granular control of which OD pairs can possibly have their paths changed and hence the impact of the application on the network since, e.g., a large subset of the OD pairs could be given just one path—the ECMP path—which would force the optimizer to limit the number of changes it suggests. The ECMP path inclusion in the OD pair path set may in certain cases be necessary for the application to be able to roll back in a controlled fashion to the network state just prior to application introduction. OD pairs restricted to a path set consisting of one default path are in some embodiments labeled unmanaged. Conversely OD pairs with more than one path in their path set are sometimes labeled managed. In some embodiments, the default flow may be an explicitly configured path other than ECMP, this allows for e.g. custom defined default paths in unmanaged OD pairs.

The OD pairs described herein can, in certain situations, be generalized to point to multipoint pairs, i.e., having multiple destinations. The significance is that traffic sent over a point to multipoint tunnel will be forked inside the network so that each destination receives its own copy. Examining exemplary network FIG. 16 and assuming that the metrics are 1 on all links and looking at the shortest multi path in the case of origination at node H and having the destinations D and E. In this case link 8 will take the traffic to node C which will fork (replicate) the traffic to, respectively, link 3 and link 12, ensuring that node D and node E both get a copy. Note, that a feature of point to multipoint traffic, is that the traffic is not duplicated over link 8 but rather replicated at node C. The default network behavior, in case of point multipoint traffic, can generally be calculated without ambiguity when there is exactly one shortest path from the origination node to each of the destination nodes. If this is not the case the default multipath will have to be learned via configuration and/or some external means. Certain PCE and PGP embodiments described here readily accommodate point to multipoint paths. With point to multipoint paths, there is generally no load balancing for traffic belonging to a generalized point to multipoint OD pair—hence while an ECMP structure can be used to describe the multipoint flow the flow percentage over each used link is typically 100% of the flow at ingress.

Although described with reference to networks generally, it should be understood by a person of ordinary skill in the art that the embodiments described herein could be implemented in more specific networking environments or other environments where managing the routing of data may be important. For example, in certain embodiments, the methods and systems described herein may be implemented in an Ethernet environment, such as a data center communications network. In such a network, traffic flows are traditionally managed by static routing in either a two or three tiered aggregation hierarchy of routers and switches. This policy, however, can lead to similar oversubscription problems and congestion as described throughout the specification. For example, in the case of a data center, each of the servers may be analogous to the edge nodes in FIG. 21 and the core and aggregation nodes in FIG. 21 may be the Ethernet switches/routers. The communications network within the data center that interconnects the servers may be as complex or more complex, than in typical networks. Accordingly, when a request enters the data center, it may be received at a one server which might, in an exemplary embodiment, coordinate with the other servers (access points or edge nodes) to fulfill the request. Accordingly, the servers will need to communicate and/or transfer data across the network (and via the core and aggregation nodes) that interconnects them. In exemplary embodiments, the methods and systems described herein may be implemented in connection oriented packet switched environments, such as an optical transport network.

FIG. 16 illustrates an exemplary network topology with eight core nodes (labeled A to H) and twelve core links (labeled 1 to 12). Access nodes are not shown, but it is implied that all core nodes will be connected to an access node and have traffic entering or leaving the network. This exemplary network is used to illustrate the two path sets; Initial Candidate Set (ICS) and the Pruned Candidate Set (PCS), discussed in more detail elsewhere herein.

Only one OD pair is discussed, however, it is likely that there is a full mesh of OD pairs (56 OD pairs in total). Table 1, below, shows the ICS of paths for an OD pair between A-E.

TABLE 1
Initial Candidate Set (OD pair A-E)

{1, 2, 3, 4}
{1, 2, 12}
{1, 2, 8, 7, 6, 5}
{1, 11, 5}
{1, 11, 6, 7, 8, 12}
{1, 11, 6, 7, 8, 3, 4}
{10, 5}
{10, 11, 2, 3, 4}
{10, 11, 2, 12}
{10, 6, 7, 8, 12}
{10, 6, 7, 8, 3, 4}
{9, 6, 5}
{9, 6, 11, 2, 3, 4}
{9, 6, 11, 2, 12}
{9, 7, 8, 3, 4}
{9, 7, 8, 12}

A total of 16 paths have been enumerated, which are all the possible paths, excluding cycles, from node A to node E. In larger network topologies (e.g., over 50 nodes), there may be many thousands of paths per OD pair and it is often not desirable (or necessary) to find every possible path. Instead a systematic strategy for building a diverse path set, including a shortest path, without traversing the whole search space is often desirable. A part of such a strategy may be limiting the depth of the search, which translates to limiting the maximum number of hops (number of links) that the path can be.

TABLE 2
Pruned Candidate Set (OD pair A-E)

{10, 5}
{9, 6, 5}
{1, 2, 12}
{1, 11, 5}
{9, 7, 8, 12}

Table 2 lists a possible PCS of paths generated by pruning the ICS in Table 1 to the best five paths. In this example, the number of hops was used as the metric for determining the order of the paths. It can be seen that this simple metric chooses the shortest path, then the next shortest path and so on. On careful examination of the ICS, it can be seen that there are two 4 hops paths ({1, 2, 3, 4} and {9, 7, 8, 12}). In this case, only the best five paths were selected, so a tie break method is used to select one path over the other. A method that the PGP employs may be to consider the links contained in the paths that have already been selected and then select the new path based on the maximum difference of these links. In this case, both candidate paths contain two links that are in paths which are already contained in the PCS. The path {1,2,3,4} contains link 1 which has already been selected twice previously. Each of the two previously selected links in the path {9,7,8,12} were only selected once. Hence the latter path may be preferable from a path diversity perspective.

In certain embodiments, the network data may include, for example, information about the topology of the network (e.g., which nodes are connected by which links), various properties pertaining to the links (e.g., link metrics, link capacity, propagation delay, link affinities, etc.) and an enumeration of the OD pairs whose path flows need to be optimized along with various constraints on these OD pairs (e.g., maximum hops, maximum delay, administration group, geographic routing, etc.) which is met by the optimized solution. Additional path flow constraints may include, but not limited to, for example, path diversity, bandwidth reservations and/or class of service. To illustrate the effects of link affinities and administration groups consider again FIG. 16. An illustrative, but in practice unlikely, configuration example is the following: assume that all links with even i.d. numbers have the affinity green associated and all the links with odd id numbers have the affinity red associated. Re-examining the OD pair from A-E and assuming that no administrative groups have been configured for this OD pair and the above link affinity configuration is immaterial. The results are shown in table 2. Next, examine an OD pair from C-E and assume that this OD pair has administrative groups configured in a way that signals that it must use links with the green affinity. Looking at the topology, it becomes evident that there is only one path between C-E which consists of only even numbered links, i.e., the direct path {12}. Hence, the PCS for this OD pair will only consist of this one path. Examining an OD pair from B-E with the administrative group configuration “use only red links” also yields only one possible path, i.e., the path {11,5}. These somewhat extreme examples illustrate that the combination of administrative groups and link affinities allows for greater granularity in defining which links a particular OD pair is allowed to use.

In exemplary embodiments, the network state information may include, for example, information about the availability of the various links in the network topology to carry data. This availability may, in exemplary embodiments, be determined through a combination of operational and administrative states of a link, as well as the availability of any link groups to which a link belongs. Additional link availability criteria may include, for example, membership of shared risk link groups (SRLG), fiber bundle availability, node availability and/or site availability.

Once the PGP has completed, the PGP returns (2) a PCS to the business logic module. For each enumerated OD pair the PCS contains a set of paths which satisfy the constraints imposed on the OD pair while also only utilizing links which are available as determined by the network state information. Once the PCS data is returned to the business logic, it is cached (3), (4) for subsequent use by the PCE. At this point, the PGP phase is complete and in exemplary embodiments, may only be re-executed to, for example, generate a new PCS to accommodate changes to the network data and/or network state information. It may be significant for performance reasons that the PGP does not get re-executed when only the traffic load has changed since the last optimization. Embodiments may also leverage the asymmetry between links going down and links becoming available. In case of links going down, immediate PGP action is likely required since most often the failed link(s) will be used in some of the OD pairs PCS. On the other hand and assuming that all OD pairs have available paths immediate PGP action may not be needed when bringing links (back) into service since a valid PCS for all OD pairs already exists. The currently used PCS set is likely to be somewhat sub optimal compared to what a new PGP execution would yield, but in some embodiments, this may be an acceptable trade off compared to immediately re-running the PGP.

After the PGP phase is complete, the process continues to the optimization phase. In exemplary embodiments, the optimization phase is triggered when either the PCS changes (e.g., due to a facility failure) or a new set of load demands is collected. To start this phase, the business logic module retrieves the appropriate PCS data from cache memory (5), (6). The business logic module then sends the PCS data along with a recent set of demands (7) to the PCE for optimization. For each OD pair, the PCE selects the candidate from the PCS that provides (8) the best global optimization of its objective function. This solution is returned to the business logic module. In exemplary embodiments, once the new solution passes various thresholds when compared to the current solution and/or the solution is accepted by a user, the business logic module implements (9), (10) the new solution in the network.

In exemplary embodiments, the PGP phase provides a method of taking a sub-space of the total routing solution space to be used as an input to the PCE. This may, in exemplary embodiments, make the optimization problem more tractable.

In certain embodiments of the PGP, there may be a need for a programmatically efficient way of pruning a large set of paths to a smaller set in a manner that maximizes the diversity and filters out paths that may not satisfy some of the end-to-end constraints. This may be needed both at intermediate stages and as a means to control the rapidly growing number of possible paths and at the final stage for selecting the PCS. Exemplary embodiments may use a greedy approach that attempts to maximize path diversity by minimizing link re-use over the selected paths. Assume that the paths to be pruned are sorted according to path weights, meaning the sum of the link weights making up the path. For latency sensitive networks, the sorting may be done based on path latencies. The greedy algorithm, which will be referred to as the gready selector (GS) consists of an inner and an outer loop. Each iteration of the outer loop selects one path for inclusion in the pruned set. In the inner loop, a penalty function is calculated for all paths in an iterative fashion and the path with lowest penalty is tracked. At the end of the inner loop the lowest penalty path is selected for inclusion in the pruned path set. The penalty function is a way of formalizing a diverse path selection approach. An example of possible link reuse penalties are listed in table 3. The penalty function value may be defined as the sum of the link re-use penalties for each of the links in the path under consideration. Using a penalty function provides a convenient and high performance way of comparing diversity among several paths since all path comparisons reduced to integer comparisons. As an example, consider again table 1 and assume that the metric is simply the link count in the path. Applying this GS methodology without any constraints on the number of hops allowed will yield the paths listed in table 4—the penalty costs calculated via table 3 is listed in each phase as an aid to illustrate the approach. The paths selected by the GS depend quite heavily on the exact nature of the penalty costs—assume an example where all but the topmost penalty link re-use penalty is 0, i.e., a penalty is only incurred when using a path containing a link that has been used in all previously selected paths. Table 5 illustrates the paths selected with this configuration. This configuration biases the path selection more towards the lowest cost paths since the penalty for link re-use is de-emphasized. In fact, the results are identical to those obtained in table 2. This table driven path selection approach allows for some configurable trade offs between selecting short paths and path diversity and can be adjusted depending on the particular desires of, e.g., a network operator. The GS may be a configurable way of generalizing a hamming distance from path—path to path—set of paths.

TABLE 3
Link re-use penalty per link during selection of the i + 1th path

| Link usage | Link use penalty |
|---|---|
| Used in i of the previously selected i paths | 1000000 |
| Used in i-1 of the previously selected i paths | 10000 |
| Used in i-2 of the previously selected i paths | 100 |
| Used in i-3 of the previously selected i paths | 1 |
| Used in less than i-3 of the previously | 0 |
| selected i paths | |
| Not used in the previously selected i paths | 0 |

TABLE 4
Pruned Candidate Set (OD pair A-E) via penalty function

| Iteration number | Path selected | Penalty cost of path |
|---|---|---|
| 1 | {10, 5} | 0 |
| 2 | {1, 2, 12} | 0 |
| 3 | {9, 6, 5 } | 10000 |
| 4 | {9, 7, 8, 3, 4} | 100 |
| 5 | {10, 11, 2, 12} | 0 |

TABLE 5
Pruned Candidate Set (OD pair A-E) via modified penalty function

| Iteration number | Path selected | Penalty cost of path |
|---|---|---|
| 1 | {10, 5} | 0 |
| 2 | {1, 2, 12} | 0 |
| 3 | {9, 6, 5} | 0 |
| 4 | {1, 11, 5} | 0 |
| 5 | {9, 7, 8, 12} | 0 |

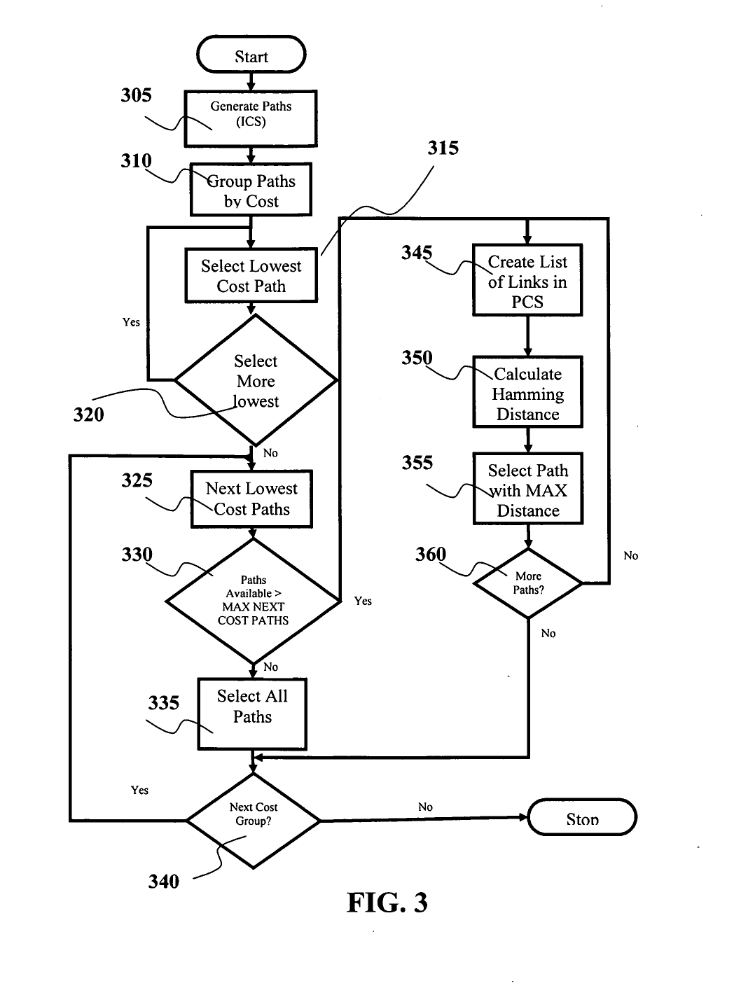

FIG. 3 is a flow chart of the PGP phase, in accordance with certain embodiments disclosed herein. In particular, as disclosed in FIG. 3, the process begins by generating a set of paths for every or almost every, OD pair—the paths are filtered so that they only contain valid paths for this particular OD pair, i.e., the link affinities in the paths match the administrative group configuration on the OD pair and if maximum latency and/or maximum hop counts are configured the paths obey these as well. This set of paths is known as the Initial Candidate Set (ICS). The ICS may, in certain embodiments, be generated by various methods (e.g., a depth first search and/or a breadth first search). The path pruning process uses the ICS as an input to reduce the number of paths to a smaller set that is more manageable for a path computation engine. This reduced set is called the Pruned Candidate Set (PCS). In exemplary embodiments, an aim of the path pruning process is to select a set of paths that are diverse from each other (e.g., where possible, they use different links).

In certain exemplary embodiments, the process performs the following steps for each OD Pair. First, after generating the paths in step 305, the process groups the paths together based on the cost of the path, at step 310. In case of latency sensitive OD pairs, processing may be based on the path latency instead of path cost. Next, the process selects the lowest cost paths and adds them to the PCS, at step 315. In certain exemplary embodiments, the maximum number of lowest cost paths may be specified, at step 320, by, for example, a NUM_LOWEST_PATHS parameter. Next, the process moves to the next group of lowest cost paths, at step 325 and if the number of paths in this group is less than or equal to (see step 330), for example, a NUM_{NEXT}_LOWEST_PATHS parameter (where NEXT is SECOND, THIRD, FOURTH, etc.), then the process selects all the paths in this cost group, at step 335. Afterwards, the process creates a list of all the links that are used in the PCS, at step 345. For the next group of lowest cost paths, the process calculates the distance (e.g., a hamming distance) between each path and the links used in the PCS, at step 350. The process selects the path that has the maximum hamming distance, at step 355, which may help ensure that this path has maximum link separation between those that have already been selected into the PCS. This sub-process is repeated until, for example, NUM_{NEXT}_LOWEST_PATHS has been selected into the PCS. These steps are repeated until there are no more NEXT lowest cost paths to choose from or until the total number of paths selected into the PCS has equaled the MAX_NUM_PATHS parameter.

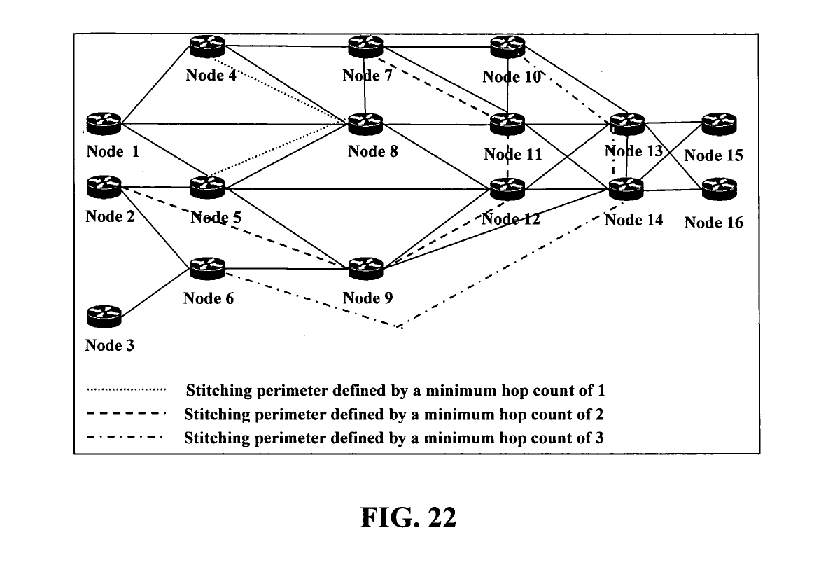

In certain PGP embodiments, a path stitching approach may be employed. A PGP employing this approach is called a Stitch Pruner or a SP PGP. The path stitching approach can be used for finding the paths for OD pairs with a minimum hop count distance of at least 2 hops by stitching together paths found with, e.g., Depth First Searches (DFS). Some embodiments may use other search techniques as, e.g., Breadth First Search (BFS). Path stitching allows for much shallower depth in the searches and hence may have certain scaling advantages compared to just doing, e.g., a full DFS or BFS. By using a stitching strategy, perimeters can be established which have the property that all or substantially all, paths for a given OD pair have to traverse each perimeter. For each OD pair and perimeter, this provides a way of segmenting the network into ingress and egress parts and this partitions the path generation problem. A perimeter is a set of Nodes. The perimeters may be defined by the minimum hop count distance. All, or substantially all, nodes that have a minimum hop count distance of d from the origination node in the OD pair form a perimeter for the OD pair provided that the minimum hop count for the OD pair is at least d+1. For an OD pair with a minimum hop-count distance of d+1, it is possible to establish different perimeters in this fashion. The Node sets defined by the perimeters are typically non-overlapping by definition. FIG. 22 serves to illustrate the path stitching approach employed by the Stitch Pruner (SP) PGP, in accordance with certain embodiments. Assume a party is interested in an OD pair from Node 1-Node 16, FIG. 22 illustrates the 3 perimeters that can be established. The 3 perimeters have a minimum hop counts distance of 1, 2 and 3 respectively from Node 1. The stitching procedure can be done on a perimeter basis. The perimeter defined by a minimum hop count distance of 2 from Node 1 may be used to illustrate an approach to the procedure. For a given perimeter, the stitching may be done on a per perimeter node basis, hence in this example based on the nodes Node 7, Node 11, Node 12, Node 9 and finally Node 2. The network may now be segmented in a left side (ingress) and a right side (egress). The strategy is to stitch paths from ingress with those on the egress side. For instance, using Node 7 as the perimeter node, we may stitch paths from Node 1->Node 7 together with paths from Node 7->Node 16. In certain instances, for simplicity and to avoid looping and/or duplicate paths restrictions may be put on both the ingress and/or egress paths used during the stitching phase. For the ingress side, all the nodes a path visits may be on or inside the perimeter. Hence, the ingress paths from Node1->Node 7 may be permitted to traverse the intermediate node set (Node 2, Node 4, Node 5, Node 9, Node 11, Node 12). An example of a valid ingress path, would be Node1->Node 5->Node 8->Node 7. Correspondingly on the egress side all, or substantially all, the nodes visited, except for the origination node typically are outside the perimeter, i.e., the path from Node 7->Node 16 may only traverse the intermediate nodes (Node 10, Node 13, Node 14, Node 15). An example of ingress path would be Node1->Node 5->Node 8->Node 7. An example of a valid egress path is Node 7->Node 10->Node 13->Node 16. A property of the described stitching strategy is that for a given perimeter, stitching through the different perimeter nodes will yield disjoint paths. In the above example, the paths generated with each of the stitch points from the set (Node 7, Node 11, Node 12, Node 9, Node 2) will typically be mutually disjoint. This is because the exit node from the ingress side is typically different for each node, i.e., the exit node for the 5 stitch points will be Node 7, Node 11, Node 12, Node 9 and Node 2. Typically, the paths for both the egress and ingress side may be created based on, e.g., the sorted and possibly truncated DFS results taking into count the node constraints and in some embodiments using the GS to create diversity. For a given perimeter, the stitched paths from the various stitch nodes can be examined together—using, e.g., the penalty function described herein, as a means to select the desired diverse set of paths for a given perimeter. An example of a performance sensitive strategy, is to stitch with the lowest min hop count perimeter first and then examine higher min hop count perimeters iteratively until sufficient diversity in the ICS has been found to allow for a high quality PCS. Another example of a strategy is to do greedy stitching, i.e., stitching for all or substantially all, possible stitch perimeters. For instances, in the above example, the stitching would based on all 3 perimeters. The latter approach would typically, yield a more diverse and bigger ICS, but at a considerable performance expense on certain bigger networks. When used in conjunction with a PGP SP the final step is to combine the results from the selected stitch perimeters, if more than one perimeter has been examined including ensuring that a shortest path is in the set. Here again, the GS may be used to make sure a diverse set of paths is selected. It is likely that there is an overlap in the paths created with the different stitch perimeters. This may be particularly correct when using gready stitching, in certain embodiments. The OD pair paths that are not taken into account when stitching with a given perimeter are those who cross from the ingress to egress side multiple times. For example, in FIG. 22 and assuming the stitch perimeter with a minimum hop distance of 2 from Node 1, the path Node 1->Node 8->Node 11->Node 13->Node 12->Node 14->Node 16 would not be allowed. This path would be allowed when stitching with a minimum hop distance of 1 or 3 from Node 1. The DFS search depth used with the stitching approach can either be statically configured and/or it will be left up to the embodiment to calculate it—too large a depth can have potentially adverse affects in a real time or substantially real time system. The SP PGP embodiments may use, for example, a strategy similar to the following in order to estimate the depth in the DFS search. Configure a minimum value, minHop and maximum value, maxHop, that the depth is allowed to have. For each OD pair, the min hop distance can be calculated using the Dijkstra shortest path algorithm with all link weights set to 1. Estimate the search depth as the average min hop distance, avHop, among all or substantially all, the OD pairs examined. Most likely, avHop will not be an integer so depth should be set to either floor(avHop) or ceiling(avHop). Finally, it should be checked that depth is in the range (minHop, maxHop). If some OD pairs have a min hop count distance that is more than 2*search depth, the stitching approach may not find any paths for this OD pair. This is typically a limited number of OD pairs and at least one path, providing a path exists, typically can always be found via the shortest path algorithm, i.e., Dijkstra. In certain embodiments, it may be advisable to not even attempt stitching for such OD pairs since it can be calculated apriori that the stitching approach will not yield any paths.

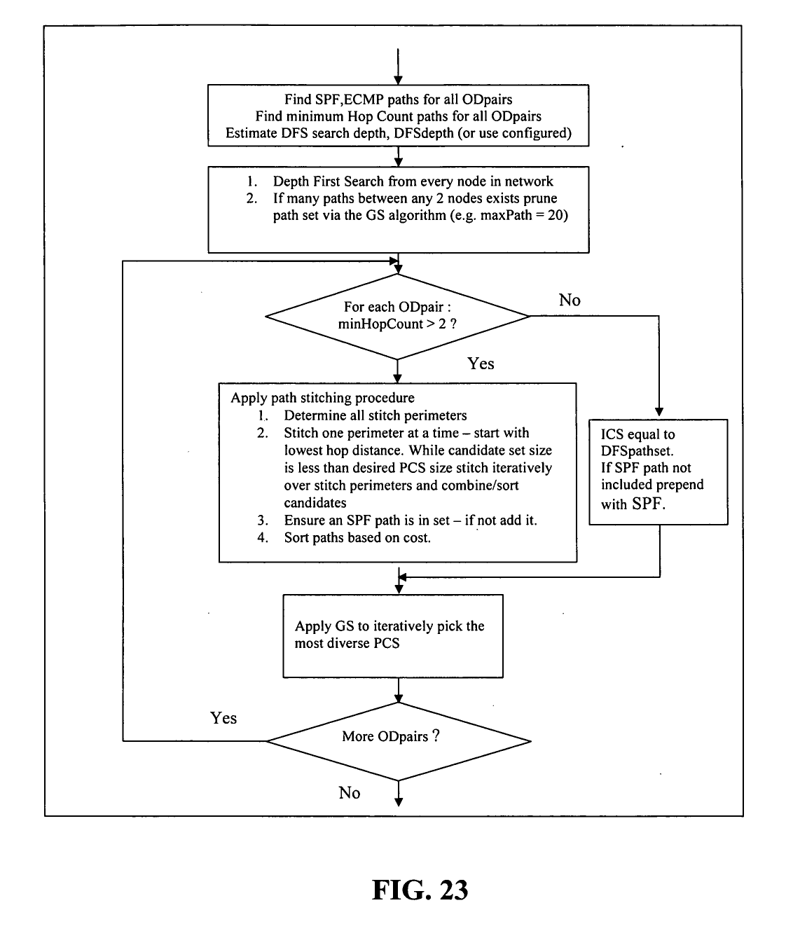

FIG. 23 illustrates the innerworkings of an exemplary embodiment of a Stitch Pruner (SP) PGP. The process described assumes that OD pairs with identical or substantially identical, administrative group configuration (or with immaterial differences) have all been grouped together in sets of OD pairs. FIG. 23 illustrates the process of selecting paths for one such set of OD pairs, in accordance with certain embodiments. The process described needs to be repeated for all or substantially all, OD pair sets. Max latency and max hopcount may or may not play into the path selection approach depending on the OD pair configuration. If they are important, they act as filters to paths generated by the stitching approach and/or the paths found by the DFS when min hop count is less or equal to two. The ICS is augmented with the shortest path if the path generation approach does not find it. As a part of the shortest path calculations, the ECMP structure is calculated for all OD pairs. Those skilled in the art will readily recognize that there are many possible variations of the details in the exemplary embodiment.

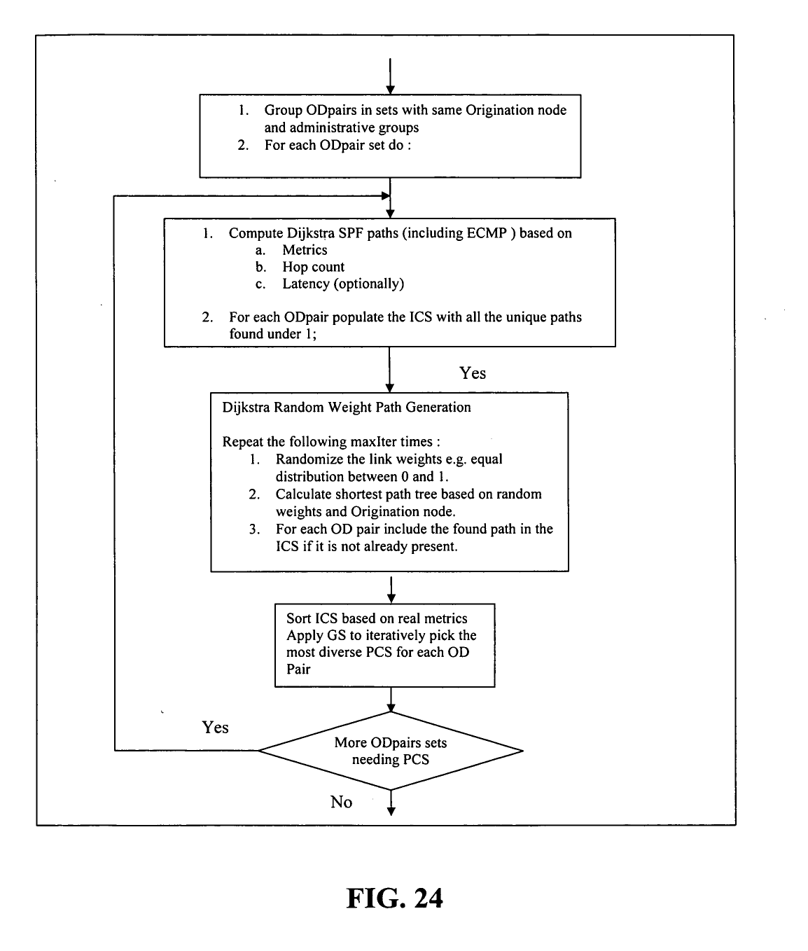

FIG. 24 illustrates an exemplary embodiment of the Random Weight Dijkstra (RWD) PGP. The RWD PGP employs the Dijkstra algorithm which has the property that it efficiently allows for the calculation of shortest paths to all or substantially all, destinations from a given origination node simultaneously or substantially simultaneously, via the shortest path tree calculated. The RWD PGP first seeds the ICS paths with the shortest paths based on, e.g., metrics, hop count (and optionally latency). In order to create diversity in each OD pairs ICS pathset, the link weights are randomized and the Dijkstra algorithm is re-run. This is done maxlter times. The paths generated via the randomized weights are included in the individual ICS path sets if they are not already members or violate latency and/or hopcount constraints. Finally, the ICS is pruned to a PCS for each OD pair using a diverse path selector as for example the GS.

The RWD PGP creates a shortest path tree and this lends the RWD to be able create point to multipoint paths with minimal additional cost compared to the point to point paths. In certain exemplary embodiments, the RWD PGP may be the pruner used for creating point to multipoint path sets.

People skilled in the art will readily see that various hybrid approaches of using the described PGP approaches are possible. For instances, one approach could be to use the SP pruner for OD pairs where the Origination and Destination nodes are close together (small minimum hopcount distance) and use the RWD pruner for the reminder of the OD pairs. Other approaches are also contemplated.

In some embodiments, it may be useful to associate some or all of the paths in the path set, each path sometimes referred to as a primary path, with an alternative path which may also be in the path set. The alternative path could be selected in a number of ways, including, e.g., as the default path for the OD pair or in some embodiments as the path with the least number of links in common with the primary path. In some embodiments, this may provide a well defined interim alternative path in case the primary path fails and a new optimization has not yet been completed. Other applications may employ a strategy where both the primary and alternative path are simultaneously active in some or all OD pairs for, e.g., high availability reasons. Those skilled in the art will recognize that there are many possible variations of how an alternative path can be applied.

In exemplary embodiments, the second phase is the PCE phase, which may, for example, include two optimization engines. The first engine may be a Local Heuristic Search (LHS) engine and the second engine may be a Genetic Algorithm (GA) engine. The GA engine conducts a broader search for optimal solutions and may be used to indicate when the LHS is converging to an optimal solution. Both of these engines are described in more detail below.

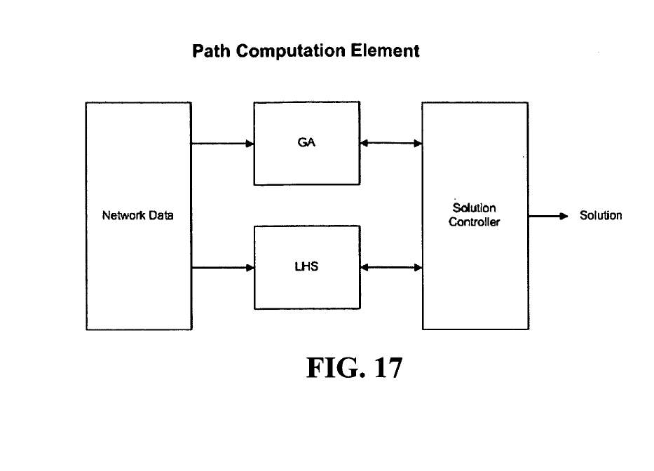

FIG. 17 illustrates the interaction of the GA and LHS components in exemplary embodiments. The GA and LHS may be run in parallel with both producing quasi-optimal solutions. The GA searches a wider space for a near-global quasi-optimal solution for the current network conditions, whereas the LHS starts with a known solution and performs a local-area search in the region around the known solution for a quasi-optimal solution given the current network conditions. By running these two systems together the GA can provide a convergence metric for the LHS, since, while the LHS can generate a quasi-optimized solution, it does not know how close its local solution is to the global optimal solution. By comparing the two solutions it is possible to assess the quality of the LHS solution and set an exit point for the LHS algorithm.

In certain embodiments, the GA could be run alone but it may not produce an ordered solution, whereas the LHS would. By ordered solution, it is meant that, given a current routing solution “A” and a quasi-optimal routing solution “B”, an order is provided for transitioning from network state “A” to network state “B” in such a way that, for each step, the network is typically not left in a worse state than it was in the previous step in terms of a network performance metric, such as the balance function. Further, the dual optimizers may provide a level of redundancy should one optimizer fail to find a solution. In exemplary embodiments, the Path Computation Element may operate as follows:

1. Receive following network data: OD pair traffic demand data and PCS.

2. GA and LHS optimizers start in parallel with these data.

3. Solution Controller monitors optimization progress and determines termination criteria based on convergence or other specified criteria.

4. The Solution Controller will return a solution as follows:
a. LHS solution when converged sufficiently to GA solution;
b. LHS solution if GA fails to find suitable solution;
c. GA solution if LHS fails to find suitable solution;
d. LHS solution if explicitly configured;
e. GA solution if explicitly configured; and
f. Other solution if explicitly configured.

In general, an LHS engine is a strategy for performing incremental intelligent route selections in communications networks (e.g. a MPLS or a Generalized MPLS network). The approach is incremental because of its nature of building up a list of explicit path changes. In certain exemplary embodiments, the LHS engine changes one explicit path for a particular OD pair at a time and hence gradually moves towards a more optimal or in case of link failures, safe solution. The suggested explicit path changes are done so that (1) the global maximum link utilization decreases with each explicit path change (Sunny Day LHS approach), (2) each explicit path change moves traffic of failed links to an available path until all failed paths have been repaired (Rainy Day LHS approach—once this is accomplished the rainy day optimizer may, in exemplary embodiments, work in the same manner as the sunny day approach and (3) each flow OD pair is only optimized once during an optimization cycle so no OD pair has its explicit path changed more than once. The rainy day optimizer may also be used to force path changes on particular OD pairs, e.g., if it is desired to revert parts or all of the traffic to the default routing solution or as a means to force some OD pairs to use particular path sets, e.g., paths that obey affinity constraints configured on the OD pairs. This process is exemplified with MPLS networks and MPLS explicit path may be used interchangeably with a Label Switched Path (LSP). In some embodiments, the restriction under (3) of optimizing each flow just once maybe waived as a tradeoff between LSP churn and final maximum link utilization. For MPLS networks, the described approach has the advantage of not reserving bandwidth on the network elements as some built mechanisms as, e.g., Constrained Shortest Path First) CSPF may do. This may eliminate the adverse effects of the flooding of MPLS-TE link bandwidth information from all links to the network elements.

In certain exemplary embodiments, the LHS approach/algorithm is designed to address current concerns in networks with explicit flows—here it is applied to, for example, MPLS networks. In particular, these concerns include morphing and churn of explicit paths (e.g., LSP, IP routes). With respect to morphing, the sunny day scenario uses the incremental approach which has the built in capability that each explicit path (e.g., LSP, IP routes) change leads to a lower maximum link utilization. For the rainy day scenario, each explicit path (e.g., LSP, IP routes) change moves traffic traversing a failed link to an available path. With respect to the churn of explicit paths (LSPs), the proposed approach would lend itself well to limiting the number of explicit path (e.g., LSP, IP routes) changes per route selection cycle. In particular, if this is an operational requirement, the algorithm can, in exemplary embodiments, be configured to stop searching for additional explicit path (e.g., LSP, IP routes) changes once a preset number of explicit path (e.g., LSP, IP routes) changes have occurred. The disclosed approach aims to get the biggest improvement in the maximum link utilization objective function possible for each explicit path (e.g., LSP, IP routes) change. Hence, the approach may target the problem of minimal churn in the network. Additionally, the proposed incremental approach may return a list of ordered explicit path (e.g., LSP, IP routes) changes and the associated max link utilization values to possibly enable a Service Provider to, for example, interactively truncate the list in order to only implement the highest impact explicit path (e.g., LSP, IP routes) changes (e.g., the top of the ordered list) if it so desired. Lastly, the algorithm disclosed reduces concerns about delay and updating since the LHS approach is a real time or substantially real time approach.

In exemplary embodiments, the LHS algorithm could be triggered in a number of ways. For example, the algorithm could be triggered by a periodic sunny day implementation (e.g., intelligent explicit path changes in which new demands are retrieved for each of the OD pairs in the network) or by a link failure, which may not be associated with new demands (e.g., the last set of demands may be used during path selection).

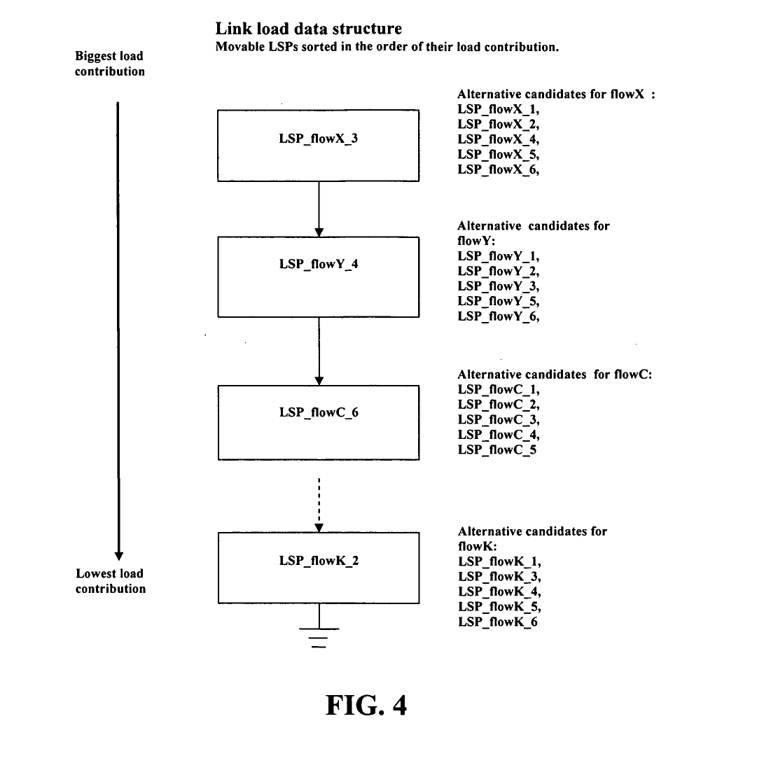

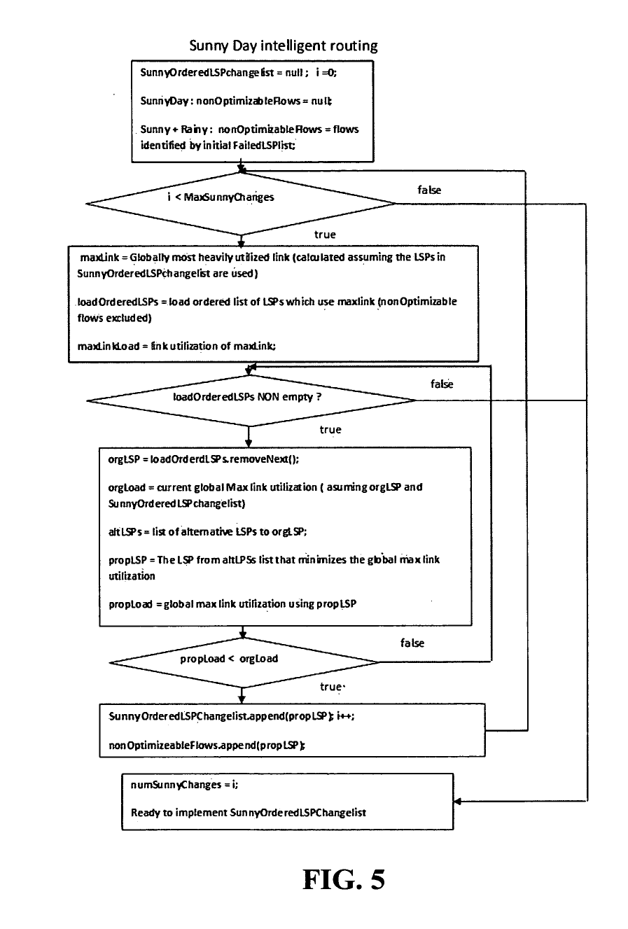

FIG. 5 illustrates an exemplary sunny day LHS approach in accordance with certain exemplary embodiments. For the periodic sunny day optimization, the following data initialization may be executed upon receiving a fresh set of demands. First, traffic demands from each OD pair are sorted from largest to smallest based on demand. Second data structures are built for each link which includes all currently active LSPs traversing the link. The LSPs on a given link are sorted from the high load to low load by virtue of using the OD pair sorting in the previous step when creating the data structure. While building the link data structure, the load on the link is calculated as well. Following this step, all of the links have an associated data structure including a sorted linked list of LSPs traversing the link and the load on link. FIG. 4 illustrates an exemplary embodiment of the link data structure that may be used. In particular, FIG. 4 illustrates a data structure for each link which includes all currently active LSPs traversing the link. The LSPs on a given link are sorted from a high load to a low load using the results from the OD pair sorting.

FIG. 4 exemplifies the link load data structure. The current link utilization is the sum of the partial link utilizations of the movable flows {LSP_flowX_3, LSP_flowY_4, LSP_flowC_6, . . . , LSPflowK 2} plus contributions from other flows that may not be movable. In the link data structure the movable flows are sorted based on their load contribution—LSP_flowX_3 being the biggest load contributor and LSP_flowK_2 the smallest load contributor. With these preliminaries in place and assuming that FIG. 4 represents the current busiest link in the network the employed strategy for globally lowering the link utilization can now be sketched. First, it is examined whether using any of the alternatives LSPs for carrying the flowX (i.e., a member of the set {LSPflowX_1, LSP_flowX_2, LSP_flowX_4, LSP_flowX_5, LSP_flowX_6}) leads to a globally lower max link utilization. Only the flows in the set that do not use the currently busiest link are of interest. The LSP in the set yielding the biggest improvement in the max link utilization metric, if any, is chosen as a candidate for use. Depending on the strategy employed (shallow or deep, as described elsewhere herein) it may be possible to proceed with examining the impact of changing the LSP carrying the next highest load contribution (i.e., LSP_flowY_4). The one LSP change on the data structure that achieves the lowest global maximum link utilization, if any, is generally tracked.

Returning to the initialization, third, recall each link is represented by the data structure illustrated in FIG. 4—the link load data structure. These data structures are subsequently internally sorted relative to each other based on the link utilizations represented by each link load data structure—facilitating ready access to the busiest links data structures. In other words, a sorted structure (linked list) of the link load data structures is created. Last, the LSP change data structure is initialized by initializing the data structure of LSP change selection so the insertion order is preserved and initializing the data structure with maximum link utilization as a function of the number of LSP changes. That is, initializing with initial max link utilization with 0 LSP changes.

In certain exemplary embodiments, the rainy day initialization may follow the same initialization sequence as described above except that in the second step the traffic going over the failed links may be accounted for differently (the details of which are explained elsewhere herein).

After the initialization, in the main loop of the sunny day approach, each iteration attempts to replace one LSP, although this replacement is not guaranteed. If there are links down (e.g., from previous failures), the process first goes to and runs the rainy day optimizer to make sure no failed links are carrying traffic. Then, after confirming that the failed links are not carrying traffic, continues with sunny day optimization.

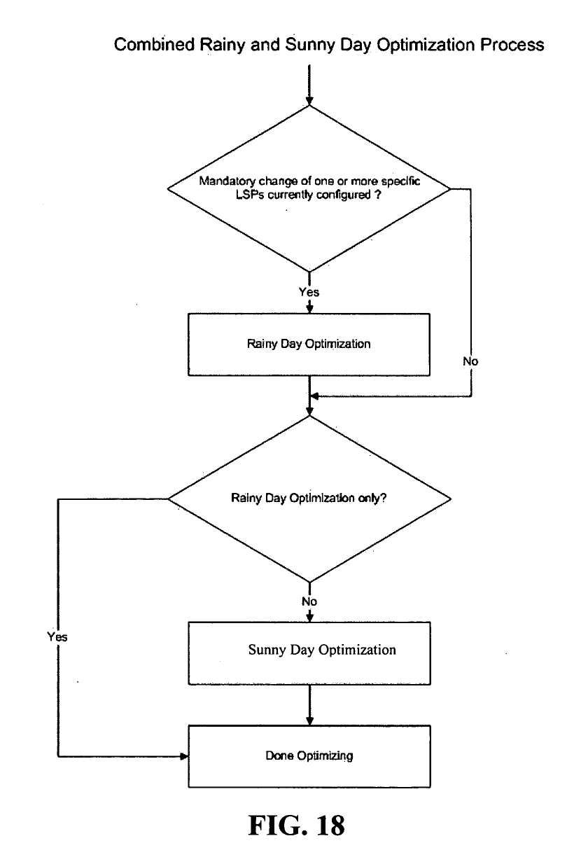

FIG. 18 illustrates the full LHS optimization process, including both the rainy and sunny day optimization. As can be seen from FIG. 18, the rainy day and sunny day optimization are run in sequence depending on configuration and need. The key difference between the rainy day optimizer and the sunny day optimizer is that for the rainy day optimizer it is deterministically determined which flows must have their paths (e.g., LSP, IP routes) changed. The optimization for the rainy day optimizer consists of selecting among the alternative LSPs for a given flow the one that yields the global minimum max link utilization. In case of ties in the global minimum max link utilization between candidate LSPs, the next highest link utilization are compared and so forth. The rainy day optimizer is targeted for optimizing after failures having occurred in the network although it can also be used to force LSP changes for specific flows in a non-failure case or as combination of the two. When links and nodes fail, the LSPs previously using these, are no longer valid and hence the associated flows need to have new LSPs configured. For the sunny day optimizer, no specific flows are a priori determined to need a LSP change, so the sunny day optimizer has a much wider search space available when attempting to globally lower the maximum link utilization than the rainy day optimizer. In terms of FIG. 4, the sunny day algorithm can, for each desired LSP change, in principle, search through all flows described by the movable LSPs for the optimal flow for which to alter LSPs while each rainy day LSP change can only consider alternatives for the specific flow needing the change. Rainy day optimization is targeted at re-routing flows that have been broken by fixing one flow at a time. The approach described here has a clear separation between rainy day and sunny day. The separation optimizes the stated goal of minimal LSP churn in that the rainy day only changes flows that must be changed. In some applications, where churn may be a secondary consideration, it is possible to interleave the 2 approaches so the ordering may not be as implied by FIG. 18.

The exemplary embodiment of the flow illustrated in FIG. 5, is described below in detail:
1. Initialize the data structures and initial conditions, i.e., non optimizable flows and the SunnyOrderedLSPchangelist. Also, set the maximum number of Sunny day changes allowed, MaxSunnyChanges (a reasonable default value for this parameter could be the number of flows being optimized). Set the results counter i to 0.
2. Check if MaxSunnyChanges bigger than i—if true go to 3. If false go to 8.
3. Determine the most heavily loaded link, maxLink and its link utilization, maxLinkLoad. Initialize loadOrderedLSPs, as the ordered list of movable LSPs described in FIG. 4 for maxLink.
4. If the ordered list loadOrderedLSPs is empty go to 8, else goto 5.
5. Pop the top LSP—orgLSP—from the loadOrderedLSPs list. Determine the LSP, propLSP, from the set altLSPs that gives the global minimum max link utilization. altLSPs is the set of alternative LSPs for the flow orgLSP describes. propLoad is set to the maximum link utilization when propLSP is used. The maximum link load, when orgLSP, is used is denoted by orgLoad. If altLSPs denotes the empty set—set propLSP equal to orgLSP and propLoad to orgLoad.
6. If propLoad is less then orgLoad goto 7, else goto 4.
7. A LSP change, propLSP, has been found that lowers the global max link utilization.

Append propLSP to the ordered LSP changelist, that is, SunnyOrderedLSPChangelist and mark the flow described by propLSP as no longer optimizable. Increment the results counter i. Go to step 2.
8. Done with Sunny day optimization.

The exemplary embodiment described above, refers to the “shallow” search approach where the search is only performed through the load ordered OD pairs on the busiest link until an LSP that makes the global max link utilization lower is found. In exemplary embodiments, a variant of this algorithm may be the “deep” search approach where all the LSPs traversing the busiest link are examined and the LSP change which gives the largest global lowering of the maximum link utilization metric is selected.

There are also many variants between “shallow” and “deep”, which in some sense describe each end of the search spectrum on the link load object. The shallow search picks the first flow where one of the LSPs gives a globally lower maximum link utilization, whereas a deep search examines the impact of all LSPs that can be changed, that is, by examining all LSPs from each movable flow. Other variants include examining a configurable maximum number of movable flows after having found a LSP change candidate. Yet another variant, is to keep searching until a maximum number of LSP change candidates have been found. Other variants between “shallow” and “deep” are also contemplated.

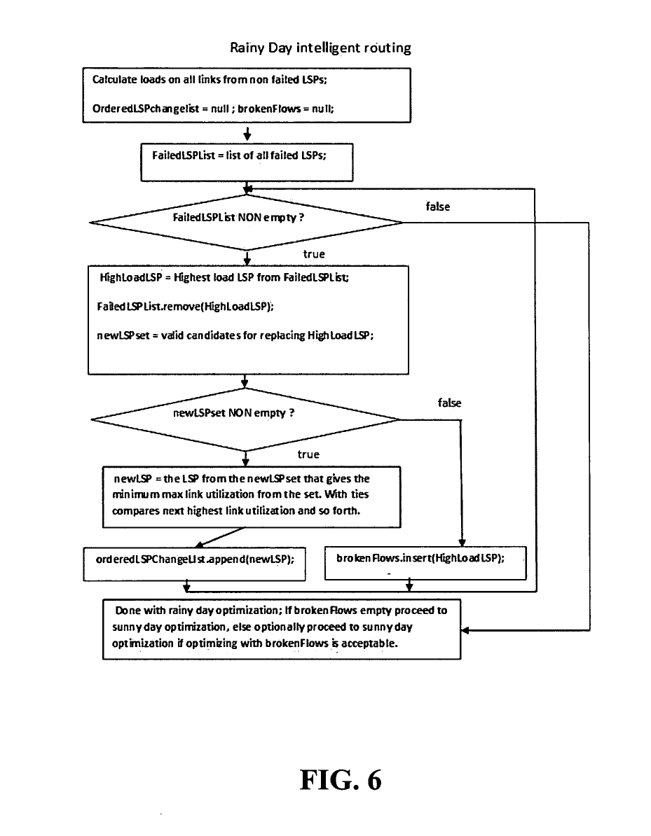

FIG. 6 illustrates an exemplary rainy day LHS approach in accordance with exemplary embodiments disclosed herein. As discussed previously, the difference in the data structure initialization approach compared to the sunny day case is how the OD pair traffic going over failed links (e.g., failed LSPs) is dealt with. In general, there are two different rainy day approaches/variants for this. First, in the robust approach, during the link object initializations the second step of the sunny day approach is modified by not considering any load from the failed LSPs. For the optimization this, in exemplary embodiments, amounts to assuming that there are no good assumptions as to where the failed traffic is currently running in the network. Accordingly, the explicit path selection is only based on the traffic going over non-failed links. Therefore, this approach is referred to as robust, because, no assumptions are made as to where the failed traffic is running in the network and hence this does not factor into the path selection strategy. Alternatively, in the Shortest Path First (SPF) approach, the modification to the second step of the sunny day approach is the assumption that the network has chosen the SPF solution for all the failed LSPs (only the OD pairs with an available path are relevant). The assumption in this case is that, based on the network topology as well as the failed links, it is possible to accurately estimate the SPF solutions implemented in the network (when taking link failures into account). With the SPF approach, the SPF path is included in the Link object initializations and accordingly, the failed traffic factors directly into how the explicit path selections are completed. Other variants between the rainy day approaches are also contemplated.

The exemplary embodiment of the main loop illustrated in FIG. 6, is described below in detail:
1. Calculate the load contributions on all links from the non failed flows (non failed LSPs). Initialize the OrderedLSPchangeList to the empty list and brokenFlows to the empty list.
2. Initialize the FailedLSPList to identify all flows that must have their LSPs changed.
3. If FailedLSPList is empty goto 9, else goto 4.
4. Find HighLoadLSP as the LSP in the FailedLSPList carrying the most traffic and remove it from the FailedLSPList. Determine the set of alternative LSPs, newLSPset, that contains alternatives for carrying the flow described by HighLoadLSP.
5. If newLSPSet empty goto 8, else goto 6.
6. Determine the newLSP as the LSP from newLSPset the gives minimum max link utilization of the set newLSPset. If several LSPs in the set newLSPset give identical minimum max link utilization the next highest link utilizations are compared and so forth.
7. Append new LSP to the orderedLSPchangeList. Goto 3.
8. Insert HighLoadLSP into the brokenFlows list. Goto 3
9. Done with rainy day optimization.
   Continue with Sunny day optimization.

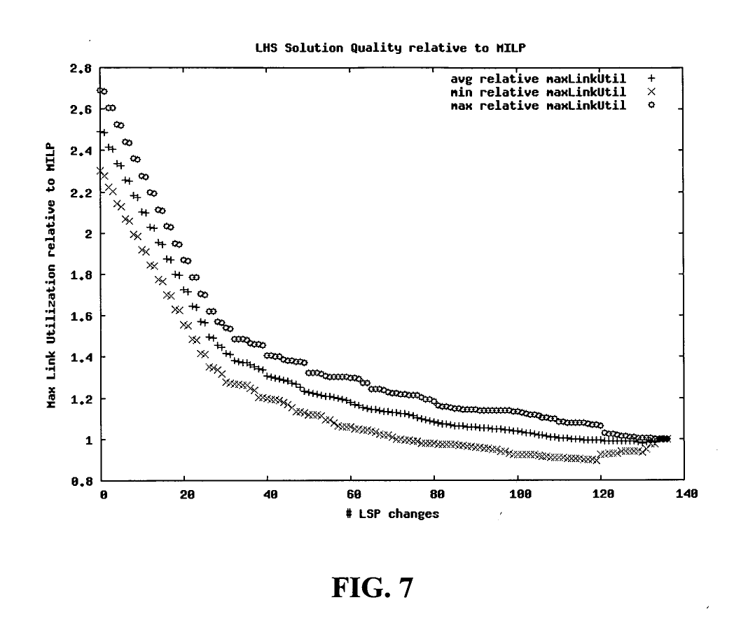

FIG. 7 illustrates results from an exemplary implementation of the sunny day LHS approach. As illustrated in FIG. 7, the Y-axis shows normalized max link utilizations as a function of the number of LSP changes. The normalization is done by dividing the maximum link utilization seen with LHS at a given number of LSP changes with the maximum link utilization found via a MILP solver (Mixed Integer Linear Programming). A relative value of 1 indicates that the maximum link utilization from the MILP approach is identical to the maximum found with LHS, a figure higher than 1 indicates that MILP outperforms LHS and a figure lower than 1 that LHS outperforms the applied MILP approach. The LHS and MILP results were obtained using a network topology with roughly 45 nodes and 600 active flows. The initial LSP selection of the 600 active flows was done by SPF (Shortest Path First). For the fixed topology, 1000 different load scenarios were randomly generated—each load scenario quantifies the traffic carried by each of the 600 active flows. The figure illustrates the impact on the maximum link utilization as function of the number of LSP changes from the initial SPF solution. The minimum, maximum and average values are indicated based on the fact that the example illustrates aggregate results from 1000 different explicit path selection runs. FIG. 7 illustrates that the LHS approach as a function of # of LSP changes converges to what is achievable with the MILP approach—in addition it illustrates that the LHS approach makes it possible to quantify the tradeoff between the number of LSP changes allowed and quality of the obtained solution. Finally, FIG. 7 illustrates to decreasing nature of the maximum link utilization as function of the # of LSP changes when using the LHS approach.

In certain exemplary embodiments, a genetic algorithm (GA) may also be used to solve the optimization problem of allocating traffic across fixed capacity links subject to traffic demand constraints. A prime consideration to be addressed in achieving this is the remapping of the constraint problem into a GA paradigm. Once this has been done, parametric tuning can be performed empirically. Several specific features of a GA approach make it attractive as a solution to the routing problem in exemplary embodiments. Specifically, with the GA approach, as the evolution progresses there is always a solution. So long as it is feasible, the solution may be implemented as an interim solution until one of greater optimality is achieved. Additionally, the GA approach can handle multiple-link failures (the LHS approach may also be capable of handling multilink failures). Further, with the GA approach, the objective function may be changed (including dynamically changed) to optimize for performance criteria based on any accurately measured parameters.

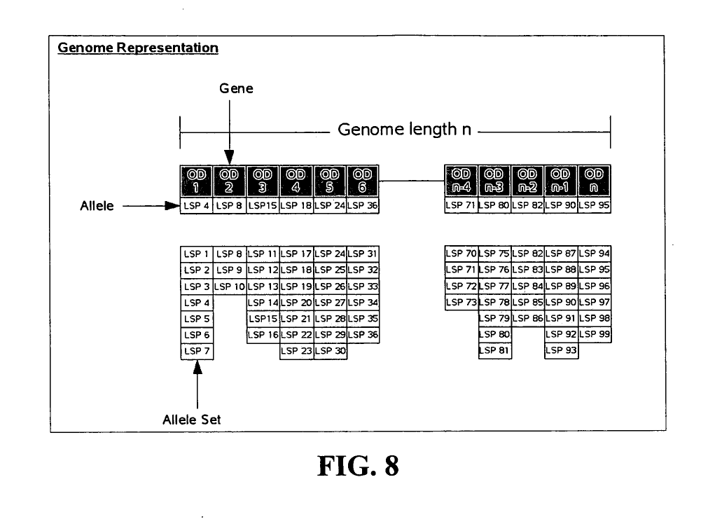

In certain exemplary embodiments related to the GA approach, the construction of the genome that is the recasting of the routing problem into the genetic algorithm context, may be an aspect of the process. The genome is a representation of the mapping of LSP to OD pair. The linear genome consists of N genes where N is the number OD pairs. The possible value that each gene may take is called an allele. Each gene corresponds to a specified OD pair and may take a number of values which map to an LSP route for that OD pair. This set is known as the allele set for that gene and is illustrated, for example, in FIG. 8. In certain embodiments, the speed of the evolutionary process may be crucial for real-time or substantially real-time application as described herein, so as much use of pointers is generally made as possible. Alleles are actually pointers to LSP objects in a list maintained by the network model. The allele set, the pointers to the LSPs that are possible routes for a particular OD pair, is formed from the pruned path generation process.

The nomenclature of the GA approach is described in more detail below.

A “gene” is an irreducible element from which genomes are constructed. In this context a gene is a data structure which contains one of several possible values (termed alleles). The gene data structure corresponds to a specific OD pair, that is, there is a one-to-one mapping between genes and OD pairs.

An “allele” is a possible value that a gene may take. In this context, an allele is a data representation of a LSP valid for a particular OD pair. There are several alleles possible for each gene. These are known as the allele set and correspond to those paths selected for each OD pair in the PCS. There is one allele set per OD pair. A gene may only have one allele value at any one time. In this context, this corresponds to one active path (e.g., LSP, IP routes) per OD pair.

A “genome” is a sequence of genes which together represent one complete solution to the optimization problem. In this context, a genome is a linear array of gene data structures with one array element for each OD Pair. The genes are ordered within the genome array by OD pair identification number. (See, for example, FIG. 8) All genomes are of the same length. In concrete terms, a genome specifies which LSP is to be used for each OD pair.

A “population” is a collection of genomes that interact with each other during the course of evolution. In this context, a population is a collection of possible optimal solutions (each represented by a genome) to the global routing problem.

The “objective function” is a measure of how well a given genome does at solving the problem at hand. In this context, the objective function returns a real number which, for each genome, indicates how well it has selected LSPs for each OD pair in terms of global performance in the network. The exact choice of objective function depends on what network performance and load characteristics are desired. Possible objective functions include, for example, balance (minimize load on heaviest loaded link), linear (minimize the sum of all link loads) exponential bias (minimize the sum of exponentially weighted link loads), minimize delay or combinations thereof. In current context, the objective function is a short algorithm that is highly configurable in accordance with engineering and business needs.

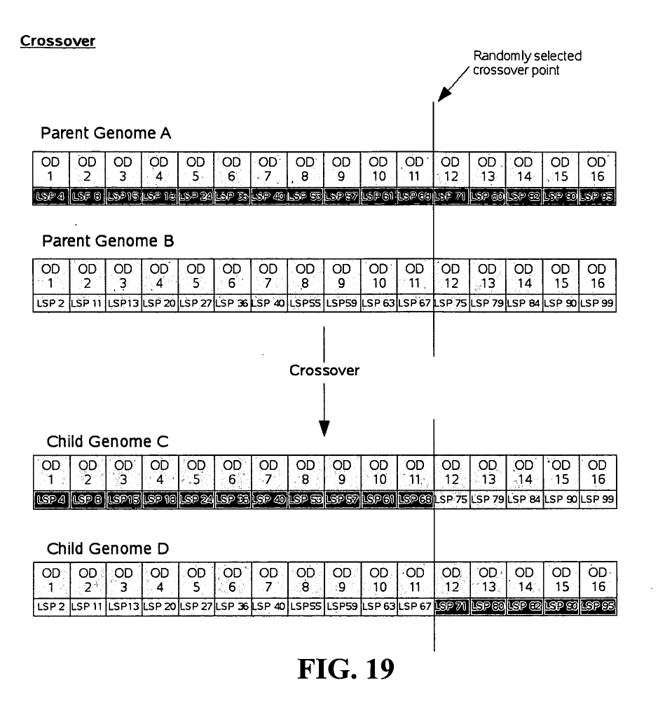

“Crossover” is the mechanism of interaction between genomes in a population. In this context and as illustrated in FIG. 19, crossover, is the swapping of blocks of contiguous elements of the linear array of OD pair data structures between two genomes (designated parent genomes) to create two new genomes (designated Child Genomes). This process is also referred to as mating. The crossover rate represents the number as a percentage of population of individuals being selected for crossover. Selection of a genome for mating is biased based on performance as determine by the objective function. Better scoring individuals are more likely to be selected for mating.

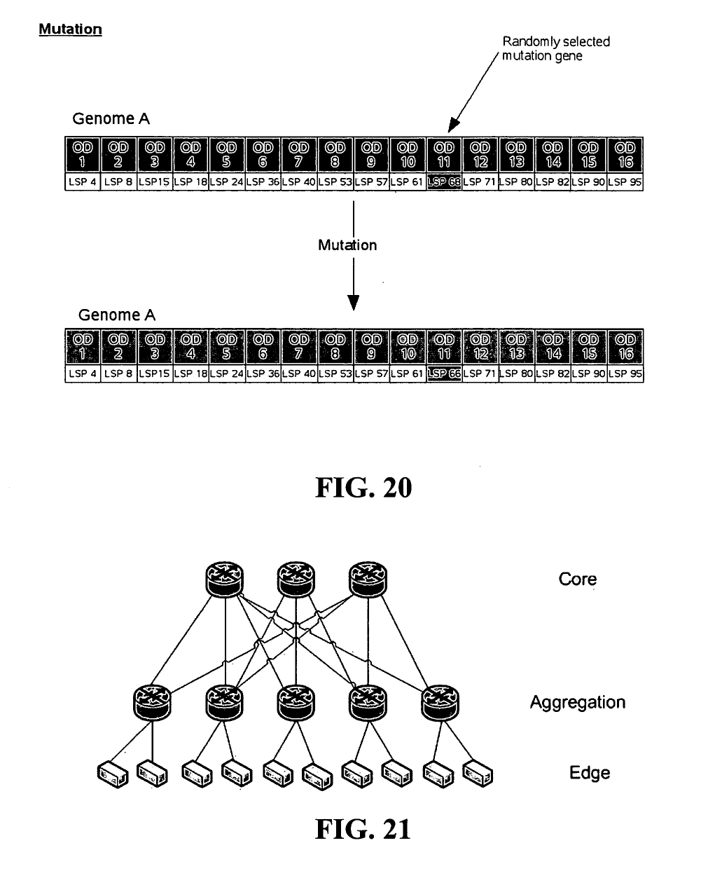

“Mutation” is a mechanism of altering a single genome. In this context and with reference to FIG. 20, mutation involves the random selection of a genome from the population and selecting an element of the OD pair data structure array, again at random and changing the allele value to another randomly selected from the allele set. That is, changing the currently selected LSP for that OD pair to another from the available candidate path set. The mutation rate is the probability that an individual will be selected to be mutated.

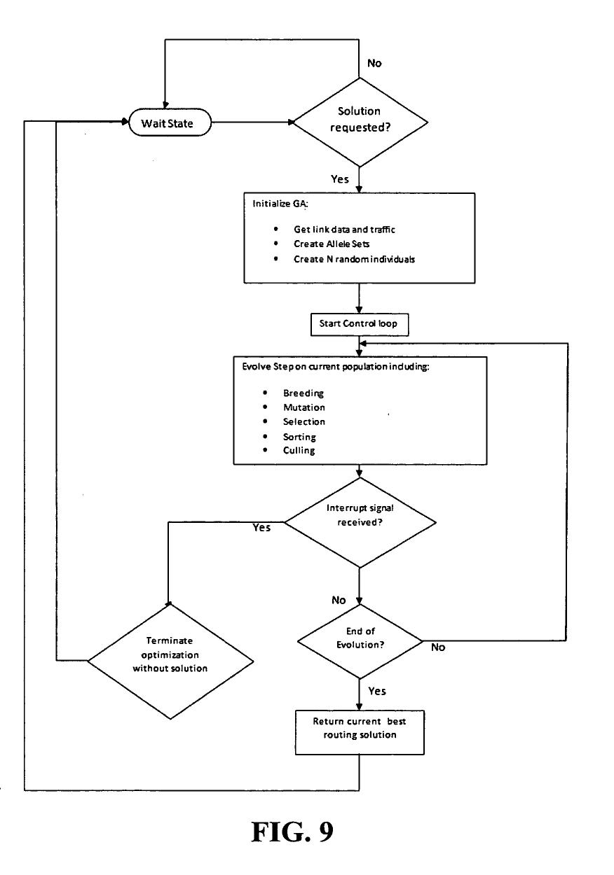

FIG. 9 illustrates the general flow of an exemplary GA optimizer. By way of specific example, the following description assumes: a network with 25 Nodes, 600 OD pairs and a PCS with 8 paths per OD Pair. Also the description assumes a population size of 20, a crossover rate of 0.5, a mutation rate of 0.05 and evolution for 100,000 generations. The objective function, in this example, is a balance function (minimize heaviest loaded link).

First, an initial population of 20 genomes is generated. That is, 20 arrays of OD pair data structures with length 600. For each of 600 OD pairs, an array of 8 candidate LSPs is created to form the allele set for that OD pair gene. A LSP from the appropriate allele set is randomly assigned to each OD Pair gene in each genome. The generation counter is set to zero.

Then, each genome's objective function is evaluated, in this example, balance. A number of genomes are randomly selected, as specified by the crossover rate, biasing selection based quality of their objective function scores. In this example, we choose 0.5 of the population or 10 genomes. Crossover is performed by randomly choosing a pair from the selected 10 genome and randomly selecting a point in the 600 OD pair data structure array. The same point in the array is used for each member of the pair. The arrays at the selected OD pair point are cut and the sub-array to the right of the cut point between the pair is swapped to create two child genomes. (See, for example, FIG. 19). Child genomes are added to the population without discarding the parent. The selection and crossover is performed another 4 times, that is, until all selected 10 parents have been paired off and mated. The Population now has 30 genomes in it: the original 20 (including the 10 selected parents) and the 10 child genomes. Each genome is evaluated for possibility of mutation. Each genome has an unbiased 5% chance of being selected for mutation. Other percents may also be selected and used. If selected, a random OD pair gene is selected and the allele (LSP) is changed by randomly picking a new one from that OD pair's allele set. Mutation does not create a new child genome. The entire population is re-evaluated against objective function and sorted based on objective function scores and, for example, the worse 10 are deleted. This restores population to its original size. The generation counter is incremented.

If an external interrupt signal is received, the process exits otherwise the process checks for a termination condition. The termination is configurable. It may be that the objective function value of the best genome has not changed in a certain number of generations or a certain amount of time has elapsed, or a set number of generations have occurred. In this example it is a generation count. If generation counter is less than 100,000, the process begins again with evaluating the genomes objective function. The LSP assignment of the best genome as the optimized routing solution is then returned.

As discussed above, the objective function is the method used to evaluate a genome. There exists a great deal of opportunity in constructing objective functions to reward one type of behavior over another. Thus, in exemplary embodiments, it may be beneficial to use an objective that generates the types of routing solutions with the desired characteristic. In exemplary embodiments, the objective function used may be the maximization of the normalized spare capacity on the maximally loaded link. This quantity is known as Balance. In exemplary embodiments, due to technical constraints in the GA, the actual objective function may not be a maximization of Balance, but rather a minimization of the normalized load on the maximally loaded link.

Evolution of the population proceeds in a step wise fashion, one generation at a time. At each generation crossover and mutator operators may be applied. The crossover operator is a breeding function performed by a swap of linear, contiguous gene subsets between two randomly selected individuals, or parents. The random selection is biased so that those members of the population with a high score in the objective function have a proportionately high probability of being selected for breeding. The breeding results in two new individuals (i.e., children that are added to the population). The other operator that may be executed, each generation is the mutator. With mutation, individuals are randomly selected with a very low (e.g., 0.002) unbiased probability of selection. If selected, a random gene in the genome is chosen for mutation and its allele is changed to one picked at random from that gene's allele set. If a genome is mutated, typically no new child genome is created as is the case with the crossover operator; rather the genome itself is altered.

After the application of the crossover and mutator operators, all individuals in the now-expanded population may be evaluated against the objective function, sorted on this basis and the lowest ranking individuals may be removed from the population such the population number is restored to its original value.

In exemplary embodiments, the allele set of each gene is created by the existing PGP algorithm.

The GA controller governs the operation of the genetic algorithm. The controller runs in its own thread and starts by initializing the GA with parameters as specified in, for example, a configuration file.

Evolution is started and the population individuals are evaluated, mutated and mated under the GA control loop (see, e.g., FIG. 9). At each step, the object function is called once for each member in the population. Evolution continues with the network model's event flag checking each generation looking for the occurrence of a network change event from the solution management module discussed above. If a change is detected, then evolution is paused until the solution management module indicates that it is ready again for re-optimization. If the event was a non-topological event, then evolution is resumed from the last generation before the event. In the case of a topological event, a snapshot of the whole population is recorded and the whole GA is re-initialized. After resetting, the population is restored from the snapshot and evolution is started, commencing from generation zero.

When evolution is completed (usually after a set number of generations), the final best individual solution is checked using a traffic audit and the distance of this solution from the pre-event best solution is measured and recorded. The thread then exits.

Topological network events are occurrences, such as link and/or node failures which result in changes in the topology of the network model. In the case, such an event occurs, evolution is suspended and a copy of the population is made. Those LSP that have been rendered inactive as a result of the event are removed and the pruning algorithm is rerun on the complete LSP set. New sets of candidates are generated for each OD pair and these are used as new allele sets for the GA. Because of change to the underlying alleles for each gene, the GA is rebuilt and reinitialized. In the case of edge node failure, several OD pairs (those with that node as an origin or destination) will likely have to be removed. This will likely change the length of the genome itself. Where possible, individuals in the new population are restored using the copy made at the end of evolution.

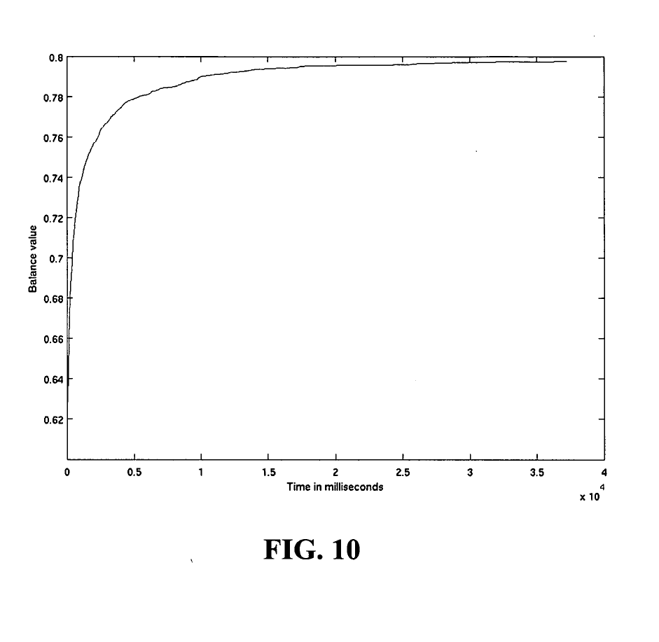

Examples of non-topological events include, in increase or decrease of capacity of existing links or changes in demand. In these cases, the evolution of the GA may be paused while the model is updated. Then evolution is resumed from the last generation. Typically, no regeneration of LSP candidates and allele sets is needed. FIG. 10, illustrates the performance of the GA optimizer under non-failure conditions. In FIG. 10, the balance value (y-axis) is the normalized spare capacity on the maximally loaded link. As shown, response times of the GA optimization were between 0.5 and 5 milliseconds to 90% of final quasi-optimal solution depending on traffic load.

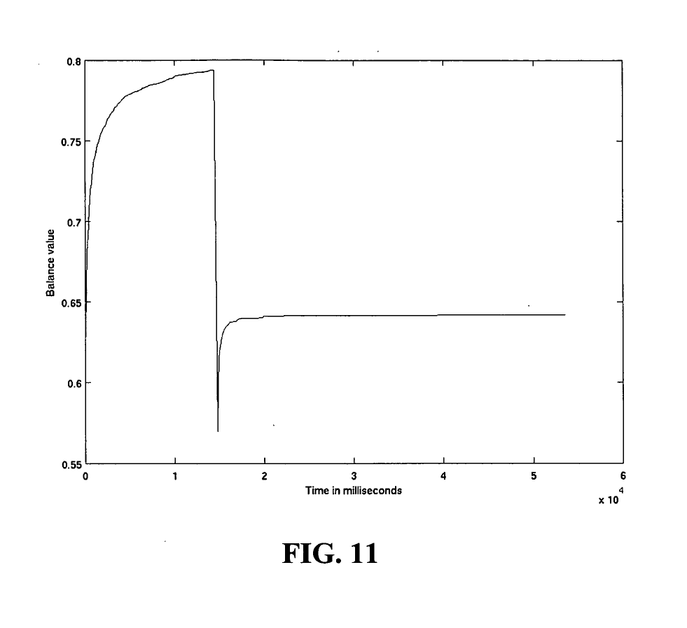

FIG. 11 illustrates the performance of the GA optimizer under conditions of 12 links failing simultaneously. As illustrated, the failure occurs at the 1.5 msec. mark and the balance value (y-axis) is the normalized spare capacity on the maximally loaded link. As shown, performance for re-optimization after topological change was often faster especially on topologies with a high number of failed links, in the case illustrated, a fiber cut with 12 links failing.

Network capacity planning can be a very computationally intensive process. Multiple variables including, for example, network topology, link capacities, traffic demands and/or network vulnerabilities are considered to arrive at a decision on capacity additions that potentially satisfy all future requirements. The network capacity planning process aims to identify the maximum load on each link under all network conditions and to add sufficient capacity to overloaded links to ensure service quality for possible future conditions. Typically, capacity planning is performed on a continuous basis for the short term (6-12 months) and long term (2-5 years).

The dynamic network optimization capability of a real-time intelligent routing engine lends itself to real-time network management during faults and outage conditions. This dynamic network optimization capability can be adapted to realize significant improvements in the network capacity planning process.

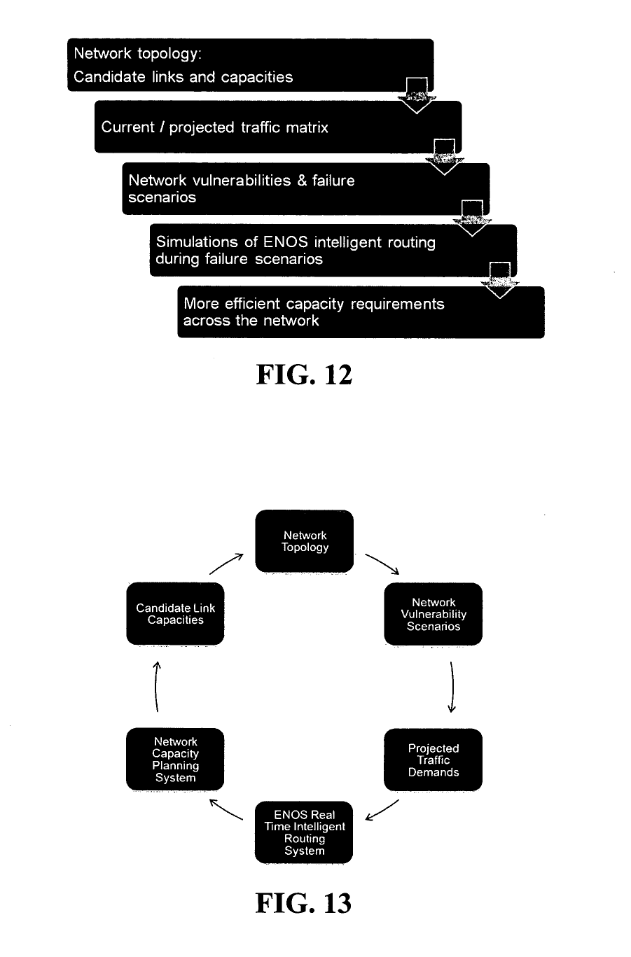

The engine ensures the most efficient network utilization under all network conditions. For a given set of traffic demands and link states, the engine computes an optimal set of paths through the network to achieve the most efficient utilization of network resources. The engine looks beyond the shortest path to identify the most optimal set of paths in the network, taking network conditions into account. FIG. 12 shows an exemplary placement of such an engine in the planning process. In particular, a product may produce simulations of its intelligent route placement to determine expected link loads under all network conditions. It may emulate the behavior of the network under the projected traffic demands by simulating its intelligent route placement. The described processes analyze the effect of its route placement across the network to determine the resulting load levels on all links. For each failure scenario, the process separately simulates the behavior of the network with its specific route placement simulation. Finally, the process collects the link utilization levels across the desired scenarios to determine the peak link load level for the projected traffic demands. By applying a standard threshold for capacity improvement, that process is able to identify the set of oversubscribed links in the network and thus, the capacity requirements across the network.

In comparison to standard shortest path first routing protocols, certain embodiments described herein ensure a net lower peak utilization level on all, substantially all of the relevant, links across all, substantially all of the relevant network conditions. By incorporating the engine in the capacity planning process, the corresponding capacity additions required to cope with traffic growth are also lower. This results in significant savings in capacity investments over the long term. FIG. 13 illustrates an exemplary interaction of the intelligent routing with capacity planning. Specifically, network capacity planning is an iterative process requiring multiple cycles of simulation to determine the most optimal capacity requirements across the network. The described process interfaces with standard capacity planning tools, providing its list of oversubscribed links per iteration as input. The capacity planning tools allow network planners to visualize the overall status of the network including the links marked as oversubscribed.

Typically, planners run multiple iterations of simulations by adding new links or capacities to the network model. Typically, potential capacity additions are made on a graded basis for each of the marked links in the network. Each stage of capacity addition may be again run through the simulations as described above to determine the feasibility of the proposed capacity addition with respect to projected traffic demands and/or vulnerabilities. These candidate link capacities form another dimension of inputs to the capacity planning cycle on subsequent iterations. Candidate link capacities may again be input to the system to begin a new cycle of network failure simulations. Finally, the candidate link capacities that satisfy all, substantially all or the relevant projected network conditions are simulated and/or rechecked. Cost and physical network build out constraints are external factors that may influence the final decision on capacity additions.

Additionally, in comparison to standard shortest path first routing protocols, a real-time intelligent routing engine ensures a net lower peak utilization level on all links across all network conditions. Consequentially, the capacity additions required to cope with traffic growth are also lower.

A real-time routing engine ensures that even with lower capacity additions, the network satisfies future potential requirements. This results in significant savings in capacity investments over the long term. For example, in some network topologies, the savings may be, for example, up to about 5%, 10%, 15%, 20%, 25%, 30%, 35%, 40% or 50% improvement in peak utilization over SPF. In terms of capacity investment costs, certain embodiments may provide cost savings of up to about 50%, 55%, 60%, 70%, 75%, 80% or 85%. In certain embodiments, the savings may be a savings of, for example, about 3%, 5%, 8%, 10%, 12%, 15% or 20% of the capital budget.

Many alterations and modifications of the present disclosure will be comprehended by a person skilled in the art after having read the foregoing description. It is to be understood that the particular embodiments shown and described by way of illustration are in no way intended to be considered limiting. Therefore, references to details of particular embodiments are not intended to limit the scope of the claims.

The embodiments described herein are intended to be illustrative of the inventions. As will be recognized by those of ordinary skill in the art, various modifications and changes can be made to these embodiments and such variations and modifications would remain within the spirit and scope of the inventions disclosed and their equivalents. Additional advantages and modifications will readily occur to those of ordinary skill in the art. Therefore, the inventions in their broader aspects are not limited to the specific details and representative embodiments shown and described herein.

1. A method for optimizing at least a portion of a data network, the method comprising:
generating a set of paths between each managed origin and destination pair;
pruning the set of paths to generate a pruned set of paths;
computing an optimum path between each managed origin and destination pair; and
wherein the optimization optionally takes into account a portion of the unmanaged origin and destination pairs within at least a portion of the data network.

2. The method of claim 1, wherein the optimization takes into account substantially all of the unmanaged origin and destination pairs within at least a portion of the data network.

3. The methods of claim 1, wherein at least one of the following is performed in a time period that is longer than substantially real time: the path generation phase, the pruning phase or the optimization phase.

4. The methods of claim 1, wherein the method is divided into at least two stages including a path generation and pruning phase as well as an optimization phase.

5. The methods of claim 1, where the path generation and pruning phase is performed using a Stitch Path—Path Generation Pruner (SP PGP).

6. The methods of claim 1, where the path generation and pruning phase is performed with Random Weight Dijkstra Path Generation Pruner (RWD PGP).

7. The methods of claim 1, where the RWD PGP generates paths for managed origin destination pairs where there are multiple destinations.

8. The methods of claim 1, wherein the optimization is performed using a Local Heuristic Search (LHS) approach.

9. The methods of claim 1, wherein the LHS approach includes a sunny day algorithm.

10. The methods of claim 1, wherein the LHS approach includes a rainy day algorithm.

11. The methods of claim 1, wherein the optimization phase is performed using a genetic algorithm.

12. The methods of claim 1, wherein the optimization accounts for changes in network topology.

13. The methods of claim 1, wherein the optimization phase is performed in less than 60 seconds.

14. The methods of claim 1, wherein the path generation and pruning phase is performed in less than 60 seconds.

15. The methods of claim 1, wherein the optimizing method is performed in less than 60 seconds.

16. The methods of claim 1, wherein over-provisioning within the data network is reduced by at least 50%.

17. The methods of claim 1, wherein peak-link utilization is improved by about 25%.

18. The methods of claim 1, wherein the data network is a Multi-Protocol Label Switching (MPLS) network.

19. The methods of claim 1, wherein the data network is a switched Ethernet network.

20. The methods of claim 1, wherein the data network is a data center communications environment.

21. The methods of claim 1, wherein the data network is an optical network.

22. The methods of claim 1, wherein the data network is a connection oriented packet switched transport network.

23. The methods of claim 1, wherein at least one of the optimization phase, the path generation phase and the pruning phase is performed in substantially real time.

24. The methods of claim 1, wherein the method results in a substantially balanced network performance and/or load characteristics.

25. A method for generating a diverse set of path options for the routing of traffic within at least a portion of a network, the method comprising:
generating a set of paths between each origin and destination pair; and
pruning the set of paths to generate a pruned set of diverse path options within at least a portion of a network.

26. The method of claim 25, wherein the path generation and pruning phase is performed in substantially real time.

27. The methods of claim 25, where the path generation and pruning phase is performed using a Stitch Path—Path Generation Pruner (SP PGP).

28. The methods of claim 25, where the path generation and pruning phase is performed with Random Weight Dijkstra Path Generation Pruner (RWD PGP).

29. The methods of claim 25, wherein the routing network is a Multi-Protocol Label Switching (MPLS) network.

30. The methods of claim 25, wherein for at least one origination and destination pair, one or more of the paths in the diverse set of path options are actively being utilized for carrying traffic or acting as standby in case of failure.

31. The methods of claim 25, wherein for some or all origination and destination pairs and at least one of the paths in the diverse path option set has an associated alternative or backup path.

32. The methods of claim 25, where the RWD PGP generates paths for origin destination pairs where there are multiple destinations.

33. The methods of claim 25, wherein the routing network is a switched Ethernet network.

34. The methods of claim 25, wherein the routing network is within a data center communications environment.

35. The methods of claim 25, wherein the routing network is an optical network.

36. The methods of claim 25, wherein the routing network is a connection oriented packet switched transport network.
